(19) United States
(12) Patent Application Publication
(10) Pub. No.: US 2026/0277756 A1
(43) Pub. Date: Sep. 17, 2026

(54) Real-Time Attestation Management For Resource Ingestion

(71) Applicant: Oracle International Corporation, Redwood Shores, CA (US)

(72) Inventors: Eric Raymond Peterson, Seattle, WA (US); Andrew James Rumer, Chapel Hill, NC (US); Benjamin Roux, Seattle, WA (US)

(73) Assignee: Oracle International Corporation, Redwood Shores, CA (US)

(21) Appl. No.: 19/263,033

(22) Filed: Jul. 8, 2025

Related U.S. Application Data
(60) Provisional application No. 63/771,131, filed on Mar. 13, 2025.

(51) Int. Cl. G06F 11/22

(52) U.S. Cl. CPC G06F 11/2289; G06F 11/2273

(57) ABSTRACT

Techniques for real-time management of attestation records for resource ingestion in a cloud environment are disclosed. A system receives attestation records in real-time. Attestation records specify validation tests associated with resources and entities for performing the validation tests. The system classifies the attestation records into validation layers based on dependencies among validation tests and resources. The system ensures the validation tests in one validation layer are successfully completed before authorizing entities associated with attestation records in a next validation layer to initiate validation tests. Entities add attestation records to a set of attestation records associated with a resource-ingestion process in real-time, even after validation tests have been initiated.

### BENEFIT CLAIMS; RELATED APPLICATIONS; INCORPORATION BY REFERENCE

This application claims the benefit of U.S. Provisional Patent Application 63/771,131, filed Mar. 13, 2025, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to cloud environments. In particular, the present disclosure relates to real-time management of attestation records for operations to be performed on hardware to be introduced into a cloud environment.

### BACKGROUND

Cloud services allow customers to use applications and data in the cloud while shifting the responsibility for maintenance of hardware and software upgrades and repair to cloud service providers (CSPs). CSPs validate the proper operation of hardware and software assets prior to handing over control of the assets to customers. The process of handing over control of assets in a cloud environment to customers for use by the customers is referred to as resource ingestion. The responsibility for validating the proper functioning of assets in a resource ingestion process may fall to various different entities. For example, one team may identify a set of required validation tests the team must perform on a server prior to handing over control to a customer. Another team may identify required tests to validate communication with servers and a switches. Yet another team may identify required tests to validate applications for spinning up virtual machines on a set of servers.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment, and they mean at least one. In the drawings:

FIGS. 1A-1D illustrate a system in accordance with one or more embodiments;

FIGS. 2A and 2B illustrate an example set of operations for managing validation tests using attestation records in accordance with one or more embodiments;

FIGS. 3A and 3B illustrate an example embodiment of a resource ingestion system.

FIGS. 4-7 are block diagrams illustrating patterns for implementing a cloud infrastructure as a service system in accordance with one or more embodiments;

FIG. 8 is a hardware system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The term “cloud computing service” or “cloud service” is used to refer to a service that is made available by a cloud services provider (CSP) to users or customers on demand (e.g., via a subscription model) using systems and infrastructure (cloud infrastructure) provided by the CSP.

In most cases, the CSP is a third-party service that specializes in providing (e.g., offering, renting, selling) cloud services to customers. The servers and systems that make up the CSP's infrastructure are separate from the customer's own on-premises servers and systems. Customers can thus avail themselves of cloud services provided by the CSP without having to purchase separate hardware and software resources for the services. Cloud services are designed to provide a subscribing customer easy, scalable access to applications and computing resources without the customer having to invest in procuring the infrastructure that is used for providing the services. In some instances, a validation entity might opt to deploy a private cloud, becoming its own provider of cloud services. In some instances, a validation entity may utilize both a private cloud and a public cloud provided by a third-party CSP, thereby forming a hybrid cloud.

There are several cloud service providers that offer various types of cloud services. There are various different types or models of cloud services including Software-as-a-Service (SaaS), Platform-as-a-Service (PaaS), Infrastructure-as-a-Service (IaaS), and others. In an IaaS model, the CSP provides infrastructure (referred to as “cloud services provider infrastructure” or “CSPI”) that can be used by customers to build their own customizable networks and deploy customer resources.

A customer can subscribe to one or more cloud services provided by a CSP. The customer can be any entity, and the like. When a customer subscribes to or registers for a service provided by a CSP, a tenancy, or an account, is created for that customer. The customer can then, via this account, access the subscribed-to one or more cloud resources associated with the account.

### TABLE OF CONTENTS

1. GENERAL OVERVIEW
2. CLOUD RESOURCE INGESTION ARCHITECTURE
3. MANAGING ATTESTATION RECORDS FOR RESOURCE INGESTION IN REAL-TIME
4. PERFORMING VALIDATION TESTS BASED ON ATTESTATION RECORDS
5. EXAMPLE EMBODIMENT
6. CLOUD COMPUTING TECHNOLOGY
7. COMPUTER SYSTEM
8. MISCELLANEOUS; EXTENSIONS
1. GENERAL OVERVIEW

One or more embodiments dynamically manage validation tests for ingesting computer resources into a computing environment. For example, a system may manage validation tests of a server in a data center prior to handing over control of the server from a services provider to a client. A system receives attestation records in real-time. Attestation records specify a validation test associated with a computing resource and a validation entity associated with the validation test. The system may receive attestation records from various entities, such as teams, operators, and applications. The validation tests may be performed by various entities. The system classifies the attestation records into validation layers. The system ensures the validation tests in a validation layer are successfully completed before authorizing entities associated with attestation records in a next validation layer to initiate validation tests. Entities may add attestation records to a set of attestation records associated with the handover of a computing resource, even after validation tests have been initiated. For example, as one set of entities is performing validation tests on hardware in a server, another entity may generate an attestation record specifying an additional test to perform on the hardware in the server. Additionally, a validation entity may generate a new attestation record specifying an additional test to perform to test the server's connection with additional servers in a network. A newly added attestation record may be associated with a particular validation layer that was previously completed. In this instance, the system transmits a notification to entities that have initiated validation tests responsive to completion of the particular validation layer. The validation entities may determine whether to re-execute the validation tests after the particular validation layer is once again complete (based on successful completion of the new validation test specified in the new attestation record).

One or more embodiments classify attestation records into validation layers to manage an execution order of validation tests. The validation layers may be based, for example, on dependencies between attestation records. Additionally, validation layers may be based on factors such as a validation entity associated with a validation test and an availability of resources associated with the validation test. A system determines if every attestation record in a validation layer has been resolved before authorizing the execution of validation tests associated with a next validation layer. As entities complete validation tests, the validation entities may generate notifications indicating a successful test. The system may resolve the attestation records based on the indications of the successful tests. Once indications have been received for each attestation record in a validation layer, the system may determine the validation layer is complete and may authorize validation tests associated with the next validation layer. Entities associated with attestation records of the next validation layer may determine whether to initiate the corresponding validation tests based on the authorization from the system.

One or more embodiments described in this Specification and/or recited in the claims may not be included in this General Overview section.

### 2. Managing Attestation Records for Resource Ingestion in Real-Time

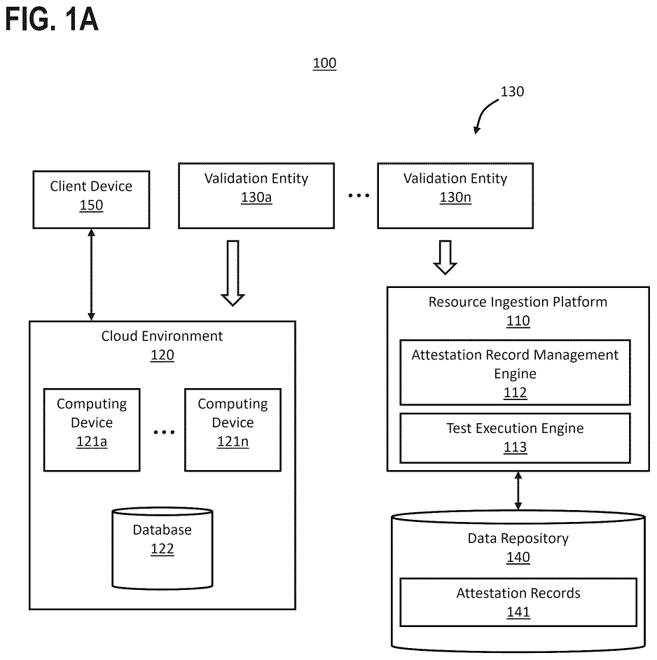

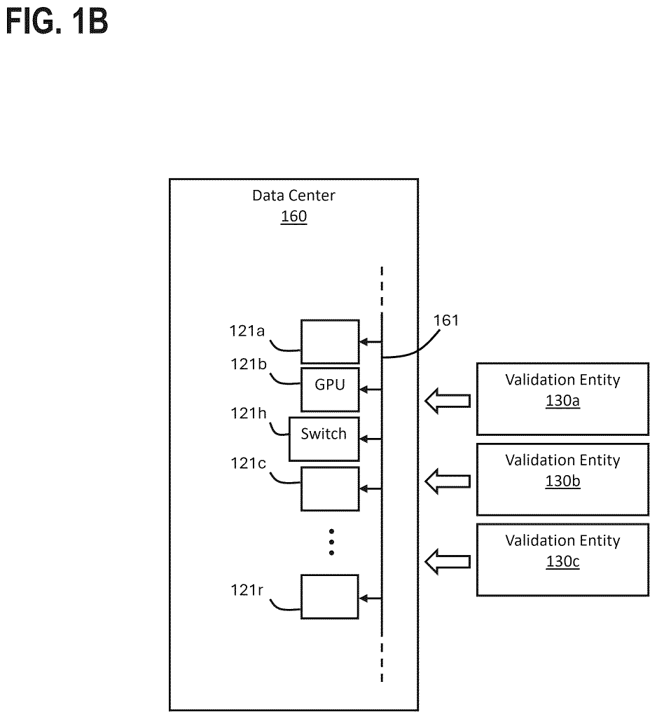

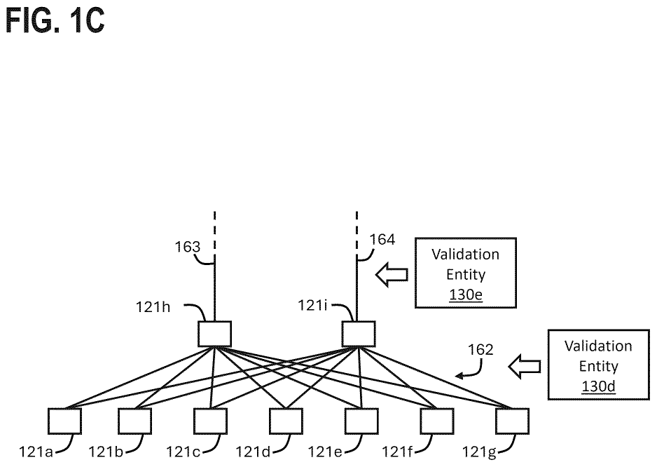

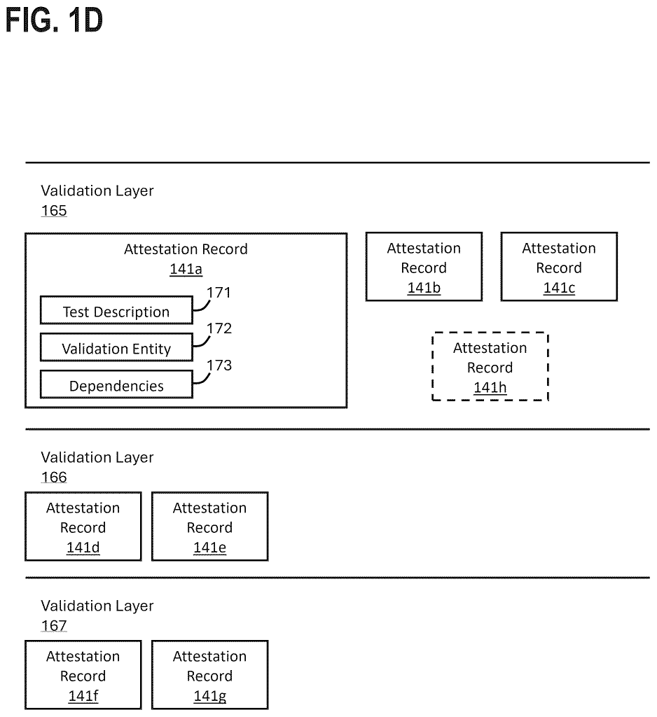

As illustrated in FIG. 1, system 100 includes a resource ingestion platform 110, a cloud environment 120, validation entities 130, a data repository 140, and a client device 150. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

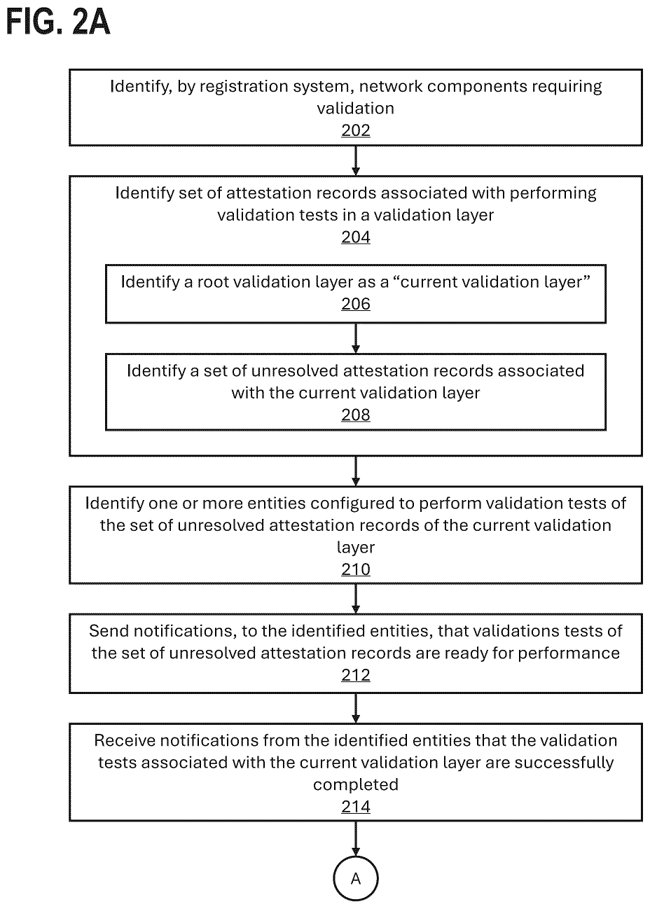

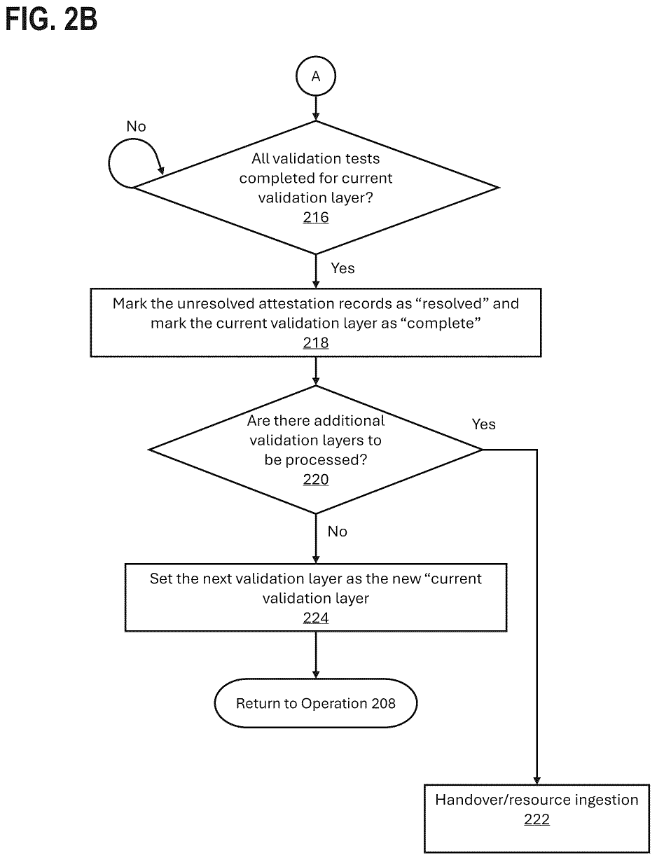

In one or more embodiments, resource ingestion platform 110 refers to hardware and/or software configured to perform operations described herein for managing attestation records and executing validation tests for resource ingestion in real-time. The resource ingestion platform 110 may include a server running software for controlling processors to analyze attestation record content, classify attestation records according to validation layers, store attestation records in a queue in memory, perform tests on external computing components, communicate with validation entities and other client devices to receive attestation records, and receive software for performing validation tests, transmit validation test results. Examples of operations for managing attestation records for resource ingestion in real-time are described below with reference to FIG. 2.

In an embodiment, the resource ingestion platform 110 is implemented on one or more digital devices. The term “digital device” generally refers to any hardware device that includes a processor. A digital device may refer to a physical device executing an application or a virtual machine. Examples of digital devices include computers, tablets, laptops, desktops, and servers.

The client device 150 accesses the computing devices 121a-1021n in the cloud environment 120. The client device 150 may access applications and data on the computing devices 121a-121n in the cloud environment 120. In an example embodiment, the computing device 121a is a server and the client device 150 is a personal computer. A user may operate the personal computer to access programs running on the server.

In an example, the cloud environment 120 is implemented as servers, switches, and supporting hardware in and across data centers. Computing devices 121a-121n include servers, routers, switches, storage devices, power systems, and cooling control systems, or other computing devices operating in data centers. In one example embodiment, the cloud environment 120 is accessed by a validation entity, such as a company or other organization, to manage the validation entity's data and applications.

The resource ingestion platform 110 manages operations to incorporate hardware and software resource into the cloud environment. In one embodiment, the resource ingestion platform 110 manages operations to validate resources, such as computing devices 121a-121n and database 122, prior to handing over control of the resources to clients. In an example embodiment, the resource ingestion platform 110 is maintained by a cloud services provider (CSP). The CSP sets up hardware in a data center, such as providing a layout of computing devices in racks, power and data transmission cables, and cooling pipes to the racks. The CSP may further configure one or more applications, such as database applications and data access and management applications to allow clients to operate CSP-provided and/or homegrown applications on the computing devices 121a-121n. The resource ingestion platform 110 ensures proper operation of hardware and software resources in a resource ingestion process prior to handing over control of the resources to the clients. Validation entities 130a-130n manage validation tests to perform in the cloud environment 120 to ensure the proper operation of the hardware and software resources.

Validation entities 130a-130n include operators, administrators, teams, and applications that perform validation tests to ensure proper functioning of hardware and software resources in the cloud environment 120 prior to making the resources available for clients to access in the cloud environment 120. One validation entity 130a may be, for example, an application managed by an operator in a data center to ensure a proper physical configuration of servers and switches in the data center. Another validation entity 130b may be, for example, an application managed by a team in the data center to ensure the proper interconnection of servers and switches to other servers and/or switches. Another validation entity 130c may be, for example, an application that runs tests on graphics processing units (GPUs) to ensure the proper functioning of the GPUs. Another validation entity 130d may be an application that tests communication characteristics between servers in one client cluster and servers in remote client clusters across a network fabric. Validation entities 130 may employ varying tests to validate the proper functioning of various components in the cloud environment 120.

FIG. 1B illustrates an example of validation entities associated with validation tests on hardware in a data center 160. As illustrated in FIG. 1B, the computing devices 121a-121r, illustrated in the cloud environment 120 in FIG. 1A, are stored and managed in a data center 160. The computing devices 121a-121r include a GPU server 121b and a network switch 121h. The data center 160 includes a cooling system including a cooling pipe 161 that provides coolant to the computing device 121a-121r. Validation entity 130a performs validation tests to ensure the proper operation of the GPU server 121b. Validation entity 130b performs validation tests to ensure the proper operation of the network switch 121h. Validation entity 130c performs validation tests to ensure the proper operation of the coolant system in the data center 160.

FIG. 1C illustrates an example of validation entities associated with validation tests on network communications in the cloud environment 120. As illustrated in FIG. 1C, client devices 121a-121g are each connected to network switches 121h and 121i along data transmission paths 162. Network switches 121h and 121i are connected to additional network servers via data transmission paths 163 and 164. Validation entity 130d performs validation tests to ensure proper communications between client devices 121a-1021g and network switches 121h and 121i. Validation entity 130e performs validation tests to ensure proper communications between network switches 121h and 121i and additional network devices in a network fabric.

The resource ingestion platform 110 includes an attestation record management engine 112. The attestation record management engine 112 receives attestation records 141 from validation entities 130a-1030n. Additionally, or alternatively, validation entities 130a-130n may interact with the attestation record management engine 112 to generate attestation records 141. The attestation record management engine 112 stores attestation records in a data repository 140. Attestation records 141 specify (a) a validation test to be performed on a resource and (b) a validation entity responsible for performing the test. Attestation records 141 may further specify (c) dependencies among attestation records and/or validation layers.

In one or more embodiments, a data repository 140 is any type of storage unit and/or device (e.g., a file system, database, collection of tables, or any other storage mechanism) for storing data. Further, a data repository 140 may include multiple different storage units and/or devices. The multiple different storage units and/or devices may or may not be of the same type or located at the same physical site. Further, a data repository 140 may be implemented or executed on the same computing system as the resource ingestion platform 110. Additionally, or alternatively, a data repository 140 may be implemented or executed on a computing system separate from the resource ingestion platform 110. The data repository 140 may be communicatively coupled to the resource ingestion platform 110 via a direct connection or via a network.

Information describing attestation records 141 may be implemented across any components within the system 100. However, this information is illustrated within the data repository 140 for purposes of clarity and explanation.

In an embodiment, the resource ingestion platform 110 includes a test execution engine 113. The test execution engine 113 may perform one or more tests specified in attestation records 141. In other words, the resource ingestion platform 110 may be included among the validation entities 130a-130n. In some embodiments, validation entities 130 identify validation tests to be performed and the test execution engine 113 implements the tests.

Examples of validation tests specified in attestation records 141 to be performed by a test execution engine 113 on one or more computing devices 121a-121n include: testing power and temperature of an operating device, validating properly installed and up-to-date BIOS and firmware, running vendor-provided tools for computing components, such as CPU chips, GPU chips, and logic chips, installing and validating drivers, validating OS kernels, validating a GPU is accessible from containers, and verifying a computing component meets specified performance benchmarks. In addition, tests may verify communications protocols and functioning communications between a target device and external devices.

Upon receiving or generating attestation records 141, the attestation record management engine 112 identifies a sequence for implementing validation tests specified in the attestation records 141 based on validation layers associated with the attestation records 141.

FIG. 1D illustrates a classification of attestation records among validation layers. As illustrated in FIG. 1D, the attestation record management engine 112 classifies attestation records 141a-141g among three validation layers 165, 166, and 167 (attestation record 141h is addressed in an example embodiment, below). Validation layer 165 includes attestation record 141a, attestation record 141b, and attestation record 141c. Attestation record 141a includes a description 171 of a test to be performed on a resource, a validation entity 172 to perform the validation test, and dependencies 173 of the test on other tests and/or validation layers.

Validation layer 166 includes attestation records 141d and 141e. The attestation record management engine 112 classifies attestation records 141d and 141e in validation layer 166 based on determining the attestation records 141d and 141e depend from validation layer 165. For example, attestation records 141a-141c may specify hardware tests performed by validation entities on processors, memory, and logic chips in a server. Attestation records 141d and 141e may specify communications tests performed by validation entities to validate the proper communication of client servers with a network switch in a row of a data center.

Similarly, the attestation record management engine 112 classifies attestation records 141f and 141g in validation layer 167 based on determining the attestation records 141f and 141g depend from validation layer 166. For example, attestation records 141f and 141g may specify communications tests between network servers in one data center and network servers in another data center.

Additionally or alternatively, the attestation record management engine 112 identifies that one or more attestation records are associated with a certain validation layer based on information specified in the attestation records. An attestation record may specify its own validation layer.

In embodiments, the attestation record management engine 112 supports real-time updating of attestation records 141, even once validation tests for resources have been started. For example, referring to FIG. 1D, the attestation record management engine 112 may authorize validation entities to perform validation tests corresponding to attestation records 141a-141c. Upon confirming successful completion of the validation tests, the attestation record management engine 112 may determine another validation entity added a new attestation record 141h to the validation layer 165. The dashed lines in FIG. 1D represent the addition of attestation record 141h to the validation layer 165 after the validation tests corresponding to attestation records 141a, 141b, and 141c were initiated. The attestation record management engine 112 may authorize the validation entity to initiate the validation test specified in the attestation record 141h, prior to proceeding to validation layer 166. In other words, the attestation record management engine 112 may prevent the validation entities associated with attestation records 141d and 141e from initiation corresponding validation tests until confirming that the validation test corresponding to attestation record 141h has been successfully completed.

In embodiments, the resource ingestion platform 110 transfers access and/or control of a computing device 121a-121n to a client device 150 upon completing a set of validation tests specified in attestation records 141 associated with the computing device 121a-121n. For example, test execution engine 113 may initiate and/or conduct hardware tests on components within computing device 121a, application tests to validate the functionality of an operating system and application running on the computing device, and communications between the computing device 121a and another computing device 121n. Upon completion of any validation tests associated with the computing device 121a, the resource ingestion platform 110 may transfer access data, such as login data and address data to the client device 150 to give the client device 150 control of the computing device 121a.

In one or more embodiments, various validation entities associated with corresponding validation tests generate attestation records specifying the validation tests to be performed in a cloud environment in a resource ingestion process. The validation entities may provide attestation in real-time, even while other validation entities are performing, or have performed, other validation tests on resources in the cloud environment. The resource ingestion platform 110 manages the sequence of validation tests in real-time by classifying the attestation records into validation layers. Upon resolution of all the attestation records and successful completion of all the validation tests, the resource ingestion platform 110 releases resources for use by clients in the cloud environment 120.

### 3. Managing Attestation Records for Resource Ingestion in Real-Time

FIGS. 2A-2B illustrate an example set of operations for managing attestation records for resource ingestion in real-time in accordance with one or more embodiments. One or more operations illustrated in FIGS. 2A-2B may be modified, rearranged, or omitted all together. Accordingly, the sequence of operations illustrated in FIGS. 2A-2B should not be construed as limiting the scope of one or more embodiments.

In an embodiment, a system identifies network resources requiring validation (Operation 202). Network resources include computing elements and devices, such as servers, switches, processors, memory, and cabling. For example, a cloud services provider (CSP) may add, upgrade or replace resources in a data center. In one example, the CSP prepares a set of switches and routers for use by a client. Operators may install computing devices into racks in a data center. Operators may connect cabling and cooling elements to the computing devices. In another example, operators may replace a graphics processing unit (GPU) with a new GPU.

Resources requiring validation include individual components and the connections between components. For example, one validation test may run a test on a processor to ensure the processor performs to specification. Another validation test may run a test on a processor and memory to ensure the processor and memory communicate to specification. Yet another validation test may test communications between a server including the processor and another server. Another validation test may test communications between a server group and another server group via one or more network switches.

While FIG. 2A illustrates an embodiment where a system identifies a network resource requiring validation, in an alternative embodiment, the system does not identify the network resource requiring validation. Instead, a validation management platform may receive attestation records associated with a network resource without having previously identified the network resource.

The system identifies a set of attestation records associated with performing validation tests in a validation layer (Operation 204). Attestation records are records generated by validation entities that specify tests to be performed on computing elements. Attestation records may be generated by various entities to perform various tests on resources. Validation entities may include applications running on a computer for testing computing elements. For example, an application may interact with a processer in a server to test inputs and outputs and processing speeds. Entities may include human operators. For example, a human operator may check physical power, cooling, and communications connections to a server. Additionally, or alternatively, a human operator may initiate and monitor validation tests performed by a computer application. Multiple different entities may generate attestation records for the same computing element. For example, a data center layout entity may generate an attestation record specifying a set of tests to ensure a server is installed securely in a server rack and that cooling, power, and communications cables are correctly installed. A processor test entity may generate an attestation record specifying a diagnostic test on processors in the server to ensure proper operation of the processors. A network test entity may generate an attestation record specifying a diagnostic test to determine whether communications through a network including network switches meets a specification.

In an embodiment, a system receives, stores, and classifies attestation records for tests to be completed prior to handing over a computing resource to a client in a cloud environment. Once all the tests specified in a set of attestation records has been completed and passed, the system may initiate handover of the computing resource to the client.

In an embodiment, a system classifies attestation records into validation layers. Validation layers may be characterized by dependencies on other validation layers. For example, a set of validation tests specified in a set of attestation records may depend on test results from another set of validation tests specified in another set of attestation records. The system classifies the sets attestation records into validation layers according to the dependencies of the validation tests. Once the validation tests in one validation layer are completed and passed, the system may initiate or authorize execution of validation tests specified in attestation records in a dependent validation layer.

In an embodiment, a registration system identifies a set of validation layers without the registration system identifying a corresponding system resource associated with the attestation records. The attestation records may include validation layer information, entity information, and test information. The validation layer information may describe, for example, an identifier of a validation layer and/or identifiers of parent or dependent validation layers.

In an embodiment, the registration system analyzes information describing validation test dependencies and/or attestation record dependencies to classify attestation records into validation layers. For example, the registration system may determine based on dependency information included in a first attestation record that the first attestation record depends on performance of a validation test associated with a second attestation record. Similarly, the registration system may determine based on dependency information included in a third attestation record that the third attestation record depends on performance of a validation test associated with the second attestation record. The system may classify the first, second, and third attestation records into first, second, and third attestation layers, respectively.

Examples of validation layers include: a validation layer related to facility validation to run tests on at least one of power system and cooling systems, a validation layer related to management network validation including validating firmware agents on servers or validating a power distribution unit to a rack in a data center, a validation layer directed to network connectivity between switches, a validation layer directed to server components, such as processors, memory, logic circuitry, and applications running on servers, a validation layer directed to communications between computing units on a same rack, a validation layer directed to computing units on different racks of a same row in a data center, a validation layer directed to validating connections between computing elements in a network plane, and a validation layer directed to validating a spine network.

In an embodiment, the system identifies the set of attestation records by receiving the attestation records from validation entities. The system may notify validation entities of a process, such as cloud network ingestion or client handover, to be performed on a resource. For example, if the system identifies a server to be ingested into a cloud environment, the system may notify a set of entities associated with ingesting servers into the cloud environment. Sets of entities may be mapped to respective resources and/or processes. The system may store a mapping of one set of entities associated with GPU servers. The system may store a mapping of another set of entities associated with database servers. The system may store mapping of entities associated with hardware upgrades, software upgrades, preparing hardware and software to turn over to customer control or management, resource fabrication, and implementing new hardware and software components in resources.

In an embodiment, the system stores a mapping of attestation records to resources and/or processes applied to the resources. The system may store a mapping of one set of attestation records associated with GPU servers. The system may store a mapping of another set of attestation records associated with database servers. The system may store mapping of attestation records associated with hardware upgrades, software upgrades, preparing hardware and software to turn over to customer control or management, resource fabrication, and implementing new hardware and software components in resources. The system may identify entities from content stored in attestation records.

In an embodiment, a system includes a resource management platform and a registration system. The resource management platform may identify a resource that requires validation tests. The registration system may be blind to a particular resource. In other words, the registration system may manage attestation records and processes for interfacing with validation entities without storing information about a resource that is the subject of validation tests. For example, if a resource management platform identifies a GPU server to be handed over to a client, the resource management platform may provide the registration system with a set of attestation records. The registration system may determine validation layers and validation entities and track completion of validation tests without identifying the GPU server as the object of the validation tests.

The system identifies a root validation layer as a “current validation layer” for purposes of validation testing (Operation 206). A root validation layer may be a layer that does not depend on any other validation layers. A validation layer depends on another layer when the performance of validation tests in one layer depend of the performance of validation tests in the other layer. For example, a set of validation tests for data communications are in a validation layer that depends on another layer that includes validation tests for testing power, since without appropriate power levels, communications cannot function. Similarly, a set of validation tests for a software application running on a device may be included in one validation layer that depends on another layer including burn-in of microprocessors, since faults in a microprocessor will affect performance of the software application.

The system identifies a set of unresolved attestation records associated with the current validation layer (Operation 208). As validation entities notify a registration system that validation tests are successfully completed, the registration system changes a label for a corresponding attestation record from “unresolved” to “resolved.” Initially, all the attestation records in a validation layer are labeled “unresolved.” As validation entities notify the registration system of successfully-completed validation tests, some of the attestation records in the validation layer may be labeled “resolved” and others may be labeled “unresolved.”

The system a validation entity identifies one or more validation entities for performing validations tests of the set of unresolved attestation records of the current validation layer (Operation 210). As discussed above, validation entities may include applications executing on a computing system and human operators managing validation tests. The system may identify the validation entities based on information included in the attestation records. The attestation records may store address information associated with validation entities. Additionally, or alternatively, the attestation records may store software code to transmit data to computer systems associated with the validation entities. For example, if a validation entity is a software program configured to run a software or hardware validation test, the attestation record may store software code to allow a registration system to communication with the software program. The software code may include application programming interface (API) endpoints, for example.

The system sends notifications to the identified validation entities (Operation 212). The notifications notify the validation entities that validation tests associated with the unresolved attestation records are ready for performance. In each validation layer, the system may authorize multiple entities to perform validation tests specified in attestation records concurrently. Alternatively, the system may authorize multiple entities to perform the validation tests sequentially. For attestation records classified in the same validation layer, the validation tests specified in different attestation records may be performed in any order. Additionally, an attestation record may specify a set of tests to be performed sequentially.

The system receives notifications from the identified entities that validation tests associated with the current validation layer have been successfully completed (Operation 214). If the system fails to receive notifications of successful validation tests, the system may re-authorize the performance of validation tests. The system may generate additional notifications to third parties that one or more validation tests failed.

In an embodiment, one validation layer corresponds to tests on physical connections to a computing device, such as physical power cables, physical cooling tubes, and physical network wires. The tests on the physical connections are performed by human operators. Another validation layer corresponds to test of software running on the computing device. A software testing application transmits test data to the software. The software testing application receives data in response to the test and checks the received data against expected data to validate the proper function of the software. Another validation layer corresponds to communications between the computing device and external devices. A communications management application may be connected to the computing device and at least one network device. The communication management application initiates communications between the computing device and the network device. For example, the communication management application may cause the computing device to transmit a set of data packets to the network device. The communication management application validates the communications functions of the computing device based on the results of the validation test.

Based on receiving the notifications that the validation tests associated with the current validation layer have been successfully completed, the system determines if all the validation tests for the current validation layer are completed (Operation 216). The system monitors a set of attestation records associated with a current validation layer until the system receives notifications from the validation entities associated with all the attestation records that all the validation tests associated with the current validation layer have been successfully completed.

The system marks previously-unresolved attestation records as “resolved.” (Operation 218). The system may modify attestation records to store data regarding the resolved attestation records. For example, attestation records may include registers that store data values. The system may modify the value in the register from a first value to a second value to change a status of the attestation record from “unresolved” to “resolved.”

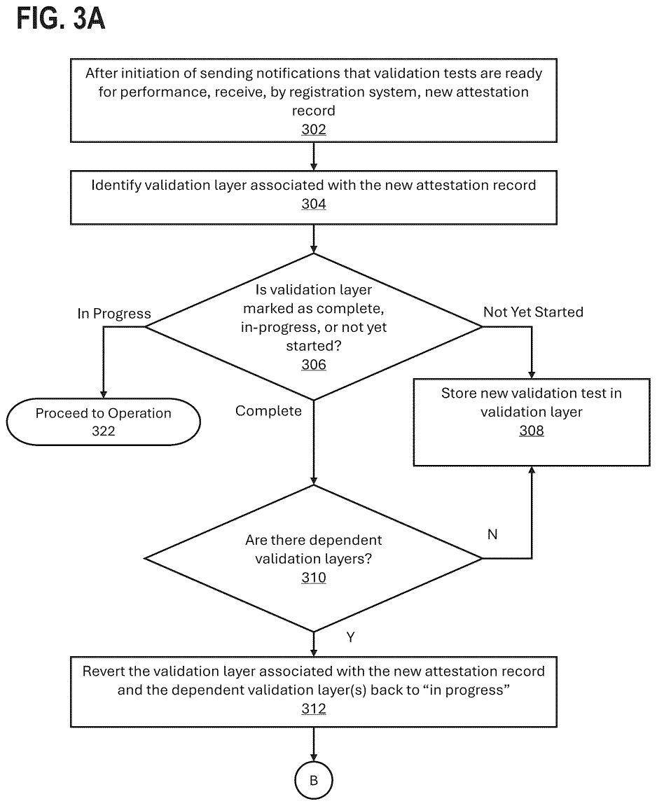

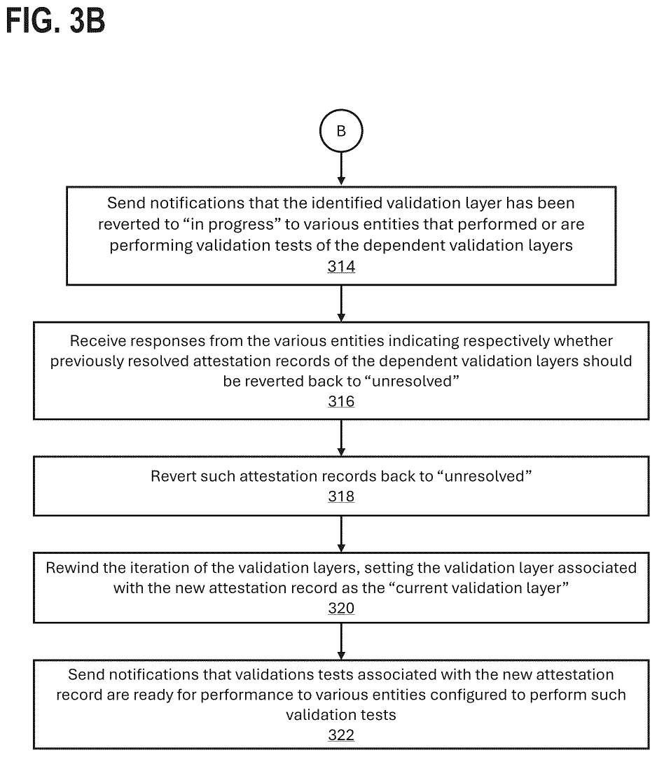

In an embodiment, entities may add attestation records to a register of attestation records in real-time. Accordingly, a system may authorize the performance of a validation test in the last unresolved attestation record in a validation layer. Upon completion of the validation test, the system may determine that a new attestation record was added to the validation layer while the validation test was being implemented. The system may authorize execution of the validation test associated with the newly-added attestation record. A process describing adding attestation records to validation layers in real-time is described in further detail in FIGS. 3A and 3B.

If the system determines the validation tests for a validation layer are completed, the system determines if additional incomplete validation layers exist. (Operation 220). For example, upon determining that all the attestation records in a validation layer are resolved and corresponding validation tests successfully completed, the system may determine if a dependent validation layer exists. A dependent validation layer may include validation tests that depend of results of validation tests in preceding layers. For example, a system may classify an attestation record corresponding to a hardware test for a processor in a server in one validation layer. The system may classify an attestation record corresponding to a network test to validate communications between the server and other servers in a dependent validation layer.

If the system determines that there are no additional validation layers to be processed, the system finalizes the ingestion of a resource into the cloud environment or hands over control of the resource to a client (Operation 222). For example, the system may perform the validation tests to ensure a server is in working order prior to handing over control of the server to a client. A handover process may include, for example, supplying a client with network addresses for devices, passwords, credentials, and security data to access hardware and software components, and documentation for operating the resources. According to another example, a resource may be made available to clients in a cloud environment. According to another example, a resource may begin transmitting data to other devices in a network.

If the system determines additional attestation records exist in another validation layer, the system sets the next validation layer as the “current” validation layer (Operation 224). The system returns to Operation 208 to identify unresolved attestation records in the new “current” validation layer.

As illustrated in FIGS. 3A and 3B, a registration system for registering attestation records may receive new attestation records in real-time, even after validation tests for a resource have been initiated. The registration system determines whether newly-received attestation records may be accommodated in existing and uncompleted validation layers.

Referring to FIG. 3A, a system may receive new attestation records for applying new validation tests to a system after the system has sent notifications that validation tests are ready for performance (Operation 302). The new attestation record may be received from a validation entity that had been notified by the system that validation tests corresponding to existing validation layers were ready for performance.

In one or more embodiments, a registration system ensures that a validation entity providing attestation records is authorized to perform validation tests on a resource. The registration system may store a list of authorized validation entities. Additionally, or alternatively, the registration system may store one or more access codes or encryption keys. The registration system may determine a validation entity is authorized to perform validation tests on the resource based on the validation entity using correct access codes or encryption keys.

The system identifies a validation layer associated with the new attestation record (Operation 304). The system may analyze the content of the attestation record to identify a validation layer specified in the attestation record. Additionally, or alternatively, the system may identify the validation layer associated with the attestation record based on metadata associated with the validation record, such as an address of a source entity associated with the record or a validation test name or identifier specified in the record.

The system determines if the validation layer associated with the newly-received attestation record is marked as completed, in-progress, or not yet started (Operation 306). The validation layers may be marked in software code executing in a registration system. As the system determines entities have completed all the validation tests associated with attestation records for validation layers, the registration system marks the validation layers as “completed,” and proceeds to notify entities associated with subsequent validation layers.

If the system determines the validation layer associated with the newly-received attestation record is marked “in progress,” the system notifies entities associated with the attestation record that validation tests are ready for performance, as described in further detail in Operation 322.

If the system determines the validation layer associated with the newly-received attestation record is marked “not yet started,” the system stores the new attestation record in the validation layer (Operation 308).

If the system determines the validation layer associated with the newly-received attestation record is marked “complete,” the system determines if there are dependent validation layers (Operation 310). If validation tests have been initiated in a dependent layer, the system may be unable to perform additional validation tests in the previously-completed layer. For example, a registration system may determine a priority level associated with a newly-received attestation record. If a priority level is low, the system may transmit a notification to a validation entity associated with the record that the corresponding validation test may not be initiated. The system may notify an administrator, and the administrator may determine that the validation test should not be performed. Alternatively, the administrator may determine that the validation test should be performed. The administrator may initiate operations to change a “completed” state of a validation layer to “in-progress.” Similarly, if the system determines a priority level of the attestation record meets a threshold, the system may determine that the validation test should be completed. The system may initiate operations to change the status of the “completed” validation layer to “in-progress” to allow the validation test to be performed.

The system reverts the validation layer associated with the new attestation record from “completed” to “in progress” (Operation 312). In addition, the system may revert a state of one or more dependent validation layers from “in progress” or “complete” to “not yet started.” For example, a system may label a first validation layer “complete” and a second validation layer “in progress” when a new validation record is received associated with the first validation layer. The system may revert the label for the first validation layer to “in progress” and for the second validation layer to “not yet started.”

The system sends notifications to validation entities that execute validation tests that the validation layer has been reverted to “in progress” (Operation 314). The system further sends notifications to validation entities associated with dependent layers that were labeled “in progress” or “completed” that these dependent layers are reverted to “not yet started.”

The system receives responses from the various validation entities indicating respectively whether previously resolved attestation records of the dependent validation layers should be reverted back to “unresolved” (Operation 316). For example, a validation entity may determine that a first validation test labeled associated with a first attestation record labeled “resolved” in a dependent validation layer would not be affected by the performance of the validation test in the new attestation record. The validation entity may indicate that the first attestation record may remain “resolved.” In contrast, the validation entity may determine that a second validation test associated with a second validation record labeled “resolved” in the dependent validation layer would be affected by the performance of the validation test in the new attestation record. The validation entity may indicate the attestation record should be reverted to “unresolved.” The validation entities may further provide confirmation that validation tests that may have been in progress have been halted.

Based on the instructions received from the validation entities, the system reverts the status of any indicated attestation records from “resolved” to “unresolved” (Operation 318). The system may store resolved and unresolved states of attestation records in a table or other memory structure. The system may store resolved and unresolved states of attestation records in metadata associated with the attestation records. For example, the records may include one or more data fields that store data indicating whether the records are labeled “resolved” or “unresolved.”

The system rewinds the iteration of the validation layers to set the validation layer associated with the new attestation record as the “current validation layer” (Operation 320). The process for labeling a validation layer as the “current” validation layer is described above in Operation 224.

The system sends notifications that validations tests associated with the new attestation record are ready for performance to various entities configured to perform such validation tests (Operation 322). The process for sending notifications that validation tests associated with attestation records are ready for performance is described above in Operation 212. The system may ensure that validation entities have halted any validation tests that were previously in progress prior to authorizing performance of the validation test associated with the new attestation record. For example, a previously-authorized validation test may include interfacing with a software application. A newly-received attestation record may correspond to a validation test to change values in an operating system register. Failing to halt the previously-authorized validation test prior to initiating the newly-received validation test may result in corruption of data or other catastrophic software failures. Accordingly, reverting a validation layer from “in progress” to “not yet started” may include ensuring that any previously-authorized validation tests in the “in progress” validation layer are halted prior to reverting the “completed” validation layer associated with the newly-received attestation record to “in progress.”

As described in the embodiment illustrated in FIGS. 2A, 2B, 3A, and 3B, a system receives and monitors attestation records in real-time to manage the ingestion of resources into a cloud environment, the handing over of computing resources to clients, or otherwise preparing and enabling a resource to perform particular operations. The attestation records are provided in real-time by validation entities responsible for performing validation tests associated with the resources. As attestation records are received, the system classifies the attestation records in validation layers based on dependencies among the attestation records. Additionally, or alternatively, the system may classify the attestation records based on the validation entities associated with the records. The real-time receipt, classification, and resolution of attestation records allows a system to implement ingestion processes without being confined to following a predefined, structured, and inflexible sequence of steps.

### 4. Performing Validation Tests Based on Attestation Records

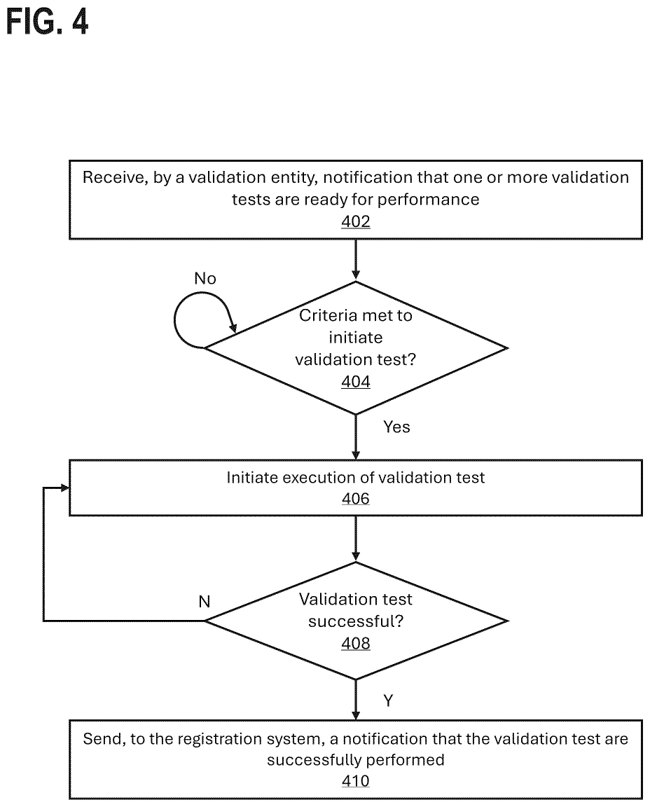

FIG. 4 illustrates an example set of operations for performing validation tests based on attestation records in accordance with one or more embodiments. One or more operations illustrated in FIG. 4 may be modified, rearranged, or omitted all together. Accordingly, the sequence of operations illustrated in FIG. 4 should not be construed as limiting the scope of one or more embodiments.

A validation entity receives a notification that one or more validation tests are ready for performance (Operation 402). Validation entities include operators, administrators, teams, and applications that perform validation tests to ensure proper functioning of hardware and software resources in the cloud environment or other distributed computing environment prior to making the resources available for clients to access in the cloud environment.

In one or more embodiments, the validation entities provide a registration system with attestation records associated with validation tests to be performed on a resource. The registration system classifies the attestation records into validation layers. When the registration system determines a validation layer is ready for execution, the registration system notifies the validation entity, as described in FIG. 2 at Operation 212.

The validation entity determines if criteria are met to initiate the validation test (Operation 404). For example, a hardware testing application may determine if other scheduled processes take priority over the validation test. The hardware testing application may queue the validation test according to task priority. As another example, a validation entity may determine if bandwidth exists to execute the validation test concurrently with other applications. A validation entity may communicate with other validation entities in the same validation layer to determine an order for performing validation tests on a resource. For example, if two entities in the same layer perform tests on a CPU, the two entities communicate to determine the order for performing the validation tests.

The validation entity initiates execution of a validation test (Operation 406). Tests include manual and electronic testing of physical structures and hardware components. Additional tests include automated and computerized tests of hardware and software components. Validation tests may include an operator physically manipulating a computing resource and taking physical measurements of the computing resource. Validation tests may include an application running on a testing computer connecting to the resource via a communications channel to transmit data to, and receive data from, the computing resource.

The validation entity determines if the validation test is successful (Operation 408). For example, an operator may ensure proper mounting of a server case in a housing and proper attachment of power and cooling connectors to the housing. An application may run burn-in, diagnostics, or other tests and compare the results with expected results. The validation entity determines if the resource performs according to specification.

If the validation entity determines a test was not successful, the validation entity may re-run the test. The validation entity may re-run the test a specified number of times before determining the resource failed the test. The validation entity may generate a notification associated with the failed test. For example, the validation entity may notify an administrator or other application of the failure and request remedial action to address the failure.

If the validation test is successful, the validation entity sends a notification to the registration system that the validation test was successfully performed (Operation 410). As discussed above in FIG. 2, Operation 214, the registration system may collect validation test results from all the validation entities associated with a validation layer determine if additional validation layers exist for performing subsequent validation tests.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

A system 500 includes a data center 510, a client device 530 in communication with the data center 510, and a resource ingestion platform 540 for preparing data center resources to connect with client devices and the network 535. The system includes validation entities 560 that submit attestation records 551 to the resource ingestion platform 540 specifying validation tests to be performed prior to handing over access of the GPU server 513a to the client.

The data center 510 is a facility that stores racks 511a and 511b of computing devices 512a-512n and 513a-513n. The rack 511b includes a GPU server 513a and additional computing devices 513b-513n. The data center includes a power source 522, cooling system 523 and external network connection 524. A power source 522 may include power outlets from a power grid as well as backup generators and/or batteries to maintain power in the event power from the power grid fails. The cooling system 523 includes pumps, conduit, and a cooling device to provide a cooled cooling fluid to the computing devices 512a-512n and 513a-513n and to direct heated cooling fluid away from the devices 512a-512n and 513a-513n. The external network connection 524 includes at least one wired or wireless data transmitter to transmit data from the devices 512a-512n and 513a-513n to the network 535. The external network connection 524 may include one or more network routers and/or switches for directing data to and from the network 535.

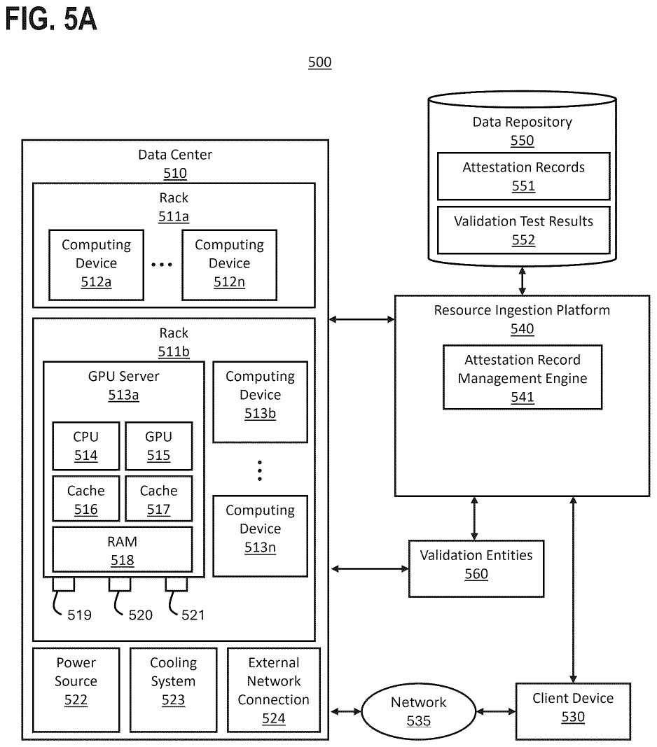

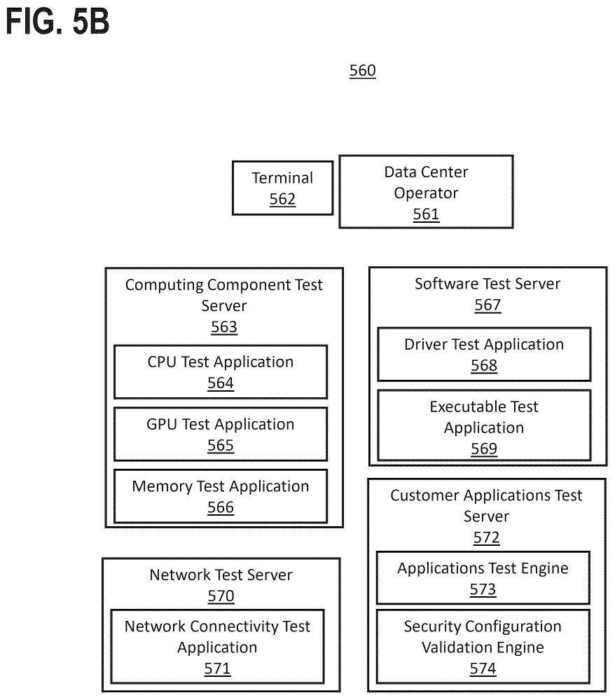

In the embodiment illustrated in FIG. 5A, the resource ingestion platform 540 is managed by a cloud service provider (CSP). The client device 530 is managed by a client of the CSP. CSPs may provide many different services to clients. For example, a CSP may provide infrastructure as a service (IaaS), platform as a service (PaaS), software as a service (SaaS), and raw metal services. IaaS refers to a CSP providing the resources for cloud computing. Clients “rent” the hardware and infrastructure, including servers, storage, and networking, from the CSP. This allows users to manage their own operating systems, middleware, applications, and data. PaaS provides a platform for developing, running, and managing applications without the complexities of managing underlying infrastructure. It offers a complete set of tools, including development environments, databases, and middleware, all managed by the provider. This allows developers to focus on building and deploying applications rather than managing the infrastructure. SaaS delivers ready-to-use software applications over the internet, accessed through a web browser or mobile app. Users pay for the application's usage on a subscription basis, and the cloud provider manages the software's infrastructure, updates, and maintenance.

The embodiment described in FIG. 5A is a raw metal, or bare metal, service. The CSP provides a client with access to a physical server, the GPU server 513a, that is not virtualized or shared with other clients. The CSP offers full control over the hardware and resources. The CSP also requires the client to manage its own infrastructure.

Because the CSP requires the client to manage its own infrastructure, the CSP turns over to the client a fully tested and functional GPU server 513a. The CSP ensures the GPU server 513a is fully tested and functional by performing a series of validation tests on the GPU server 513a. The validation tests are submitted to the resource ingestion platform 540, and carried out, by validation entities 560. The resource ingestion platform 540 manages the order of execution of the validation tests. The resource ingestion platform 540 communicates with the validation entities 560 to ensure any validation tests associated with the GPU server 513a are completed.

In an example, a data center operator 561 submits a set of attestation records 551 to the resource ingestion platform 540 via a terminal 562. The attestation record management engine 541 stores the attestation records 551 in the data repository 550. The attestation record management engine 541 stores the attestation records 551 in a layered or hierarchical structure that represents dependencies among validation tests. For example, the GPU server 513a includes a power connection port 519, a cooling system port 520, and a network connection port 521. The attestation record management engine 541 stores the attestation records 551 in a hierarchical structure that indicates the power connection port 519 of the GPU server 513a is connected to the power source 522 and power levels in the GPU server 513a are at correct values prior to testing central processing unit (CPU) 514 functionality, graphics processing unit (GPU) 515 functionality, or memory functionality in the GPU server 513a.

Examples of validation tests organized in the first validation layer or a subsequent validation layer to be performed by a data center operator 561 include management network validation for at least one of an Integrated Lights-Out Manager (ILOM), switch management, or a Rack Power Distribution Unit (RPDU). The data center operator 561 may transmit validation test results 552 to the resource ingestion platform 540 via the terminal 562.

A hardware management team may submit attestation records 551 specifying validation tests to be performed by a computing component test server 563 and a network test server 570. A software management team submits attestation records 551 specifying validation tests to be performed by a customer applications test server 572 and a software test server 567. A security management team submits attestation records 551 to be performed by the security configuration validation engine 574 in the customer applications test server 572.

The attestation record management engine 541 stores a hierarchical representation of the attestation records 551 specifying the validation tests to be performed by the data center operator 561, the computing component test server 563, the network test server 570, the customer applications test server 572, and the software test server 567.

In the example embodiment of FIGS. 5A and 5B, a first hierarchical layer of attestation records 551 includes operations performed by the data center operator 561 to connect the power connection port 519 to the power source 522 and the cooling system port 520 to the cooling system, and to test power and operating temperature at the GPU server 513a. A second hierarchical layer of attestation records includes operations performed by the computing component test server 563 to test the functionality of the CPU 514, GPU 515, cache memory 516 and 517, and random access memory (RAM) 518. For example, the CPU test application 564 runs a series of tests on the CPU 514, including a benchmarking test to assess the CPU's performance compared to expected results. The GPU test application 565 performs a benchmarking test to compare the GPU's 515 performance against expected results. The memory test application 566 runs one or more tests on the cache memory 516 and 517 and the RAM 518 to ensure data may be written to, stored in, and retrieved from the memory.

Upon determining the validation tests associated with the attestation records 551 in the second validation layer are completed, the attestation record management engine 541 identifies a third validation layer. The third validation layer includes software tests performed on software stored in, and run on, the GPU server 513a. The resource ingestion platform 540 may receive additional attestation records 551 in real-time, even after one or more validation layers has been completed. For example, after completing benchmark tests on the CPU 514 and the GPU 515, the resource ingestion platform 540 receives an attestation record 551 from the computing component test server 563 specifying a cooling efficiency test to be performed on the GPU 515. The cooling efficiency test may be configured to test the GPU's 515 thermal limits.

Upon receiving the new attestation record 551, the attestation record management engine 541 identifies dependencies among tests and determines if a test conflict exists. For example, if the cooling efficiency test would affect the results of second validation test, and if the second validation test has already been initiated or completed, the attestation record management engine 541 may determine whether to (a) generate a notification that the cooling efficiency test cannot be completed, or (b) generate a notification indicating that a test conflict exists. The attestation record management engine 541 may request that an administrator provide instructions whether to re-run the second test after completing the cooling efficiency test. On the other hand, if the attestation record management engine 541 determines that no test conflict exists between the cooling efficiency test and any other executed tests or tests specified in attestation records 551 waiting to be performed, then the attestation record management engine 541 stores the newly-received attestation record 551 specifying the cooling efficiency test in the hierarchical structure of stored attestation records 551.

The attestation record management engine 541 authorizes the software test server 567 to initiate validation tests specified in attestation records 551 of the third validation layer. A driver test application 568 tests and validates drivers for hardware components in the GPU server 513a. An executable test application 569 tests and validates software executables, including applications and agents, configured to run on the GPU server 513a. The attestation record management engine 541 authorizes the customer application test server 572 to initiate validation tests specified in the attestation records 551 of the third validation layer. The application test engine 573 tests and validates the proper functioning of client-specific applications running on the GPU server 513a.

The resource ingestion platform 540 manages the validation entities 560 that have access to the GPU server 513a to perform validation tests on the GPU server 513a. For example, one set of tests may include tests that may be performed concurrently by the computing component test server 563 and the network test server 570. Another set of tests may not be performed concurrently. The resource ingestion platform 540 determines that one validation test is completed, identifies a validation entity 560 to perform the test specified in the next attestation record 551, and grants access to the next validation entity 560 while withdrawing access permissions from the validation entity 560 that completed the previous validation test.

In an example where a validation test uses results from a previously-performed validation test, the resource ingestion platform 540 stores tests results 552 and transmits the test results to the validation entity 560 performing the next test. For example, the applications test engine 573 may use results from a GPU benchmark test to determine performance benchmarks for an application. The resource ingestion platform 540 provides the test results 552 for the GPU benchmark test to the customer application test server 572 to perform the benchmarks test for the customer application.

As discussed above, the resource ingestion platform 540 may receive additional attestation records 551 in real-time, even after one or more validation layers has been completed. For example, after completing validation tests on customer-specific applications by the applications test engine 573, the resource ingestion platform 540 may receive a new attestation record 551 to test an additional driver associated with the GPU 515. The attestation record management engine 541 determines no conflict exists between the test specified in the newly-received attestation record 551 and any other validation tests that have been performed or are scheduled to be performed. Based on determining no test conflict exists, the attestation record management engine 541 stores the newly-received attestation record 551 in a validation layer stored as the hierarchy of attestation records 551.

Upon determining the validation tests associated with the attestation records 551 in the third validation layer are completed, the attestation record management engine 541 identifies a fourth validation layer. The fourth validation layer includes security tests performed by a security configuration validation engine 574. Security configuration validation tests include vulnerability scanning, penetration testing, and configuring communication settings, authorization settings, and passwords to comply with security specifications.

Upon determining the validation tests associated with the attestation records 551 in the fourth validation layer are completed, the attestation record management engine 541 identifies a fifth validation layer. The fifth validation layer includes tests performed by the network connectivity test application 571 to test communications between the GPU server 513a and other devices in a network. One test may include directing the data center operator 561 to connect the network connection port 521 to the external network connection 524 via a cable and to test the proper connection of the cable. Another test may include transmitting data packets from the GPU server 513a, through one or more routers and switches, to the network test server 570. Upon completion of all the validation tests specified in all the attestation records 551 in all the validation layers, the resource ingestion platform 540 may connect the GPU server 513a to the network 535 and provide the client device 530 with access information to manage the GPU server 513a independently of the CSP.

Another example of validation tests performed by validation entities 560 include intra-rack validation of communications between the GPU server 513a and computing devices 513b-513n mounted or located on the rack 511b. In addition, a validation entity 560 may perform validation tests related to cohort validation, where a cohort includes server racks 511a and 511b within a defined physical boundary, such as within the data center 510. A validation entity 560 may perform validation tests related to network plane validation. According to yet another example, a validation entity may perform validation tests related to complete system validation including validation for a spine network.

### 6. Examples of Cloud Infrastructure

As noted above, infrastructure as a service (IaaS) is one particular type of cloud computing. For IaaS, the infrastructure (CSPI) provided by a CSP can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). CSPI thus provides infrastructure and a set of complementary cloud services that enable customers to build and run a wide range of applications and services in a highly available hosted distributed environment. The customer does not manage or control the underlying physical resources provided by CSPI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CSP, a tenancy, or account, is created for the customer. A tenancy is a secure and isolated partition within the CSPI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CSP may provide a console that enables customers and network administrators to configure, access, and manage resources deployed in the cloud using CSPI resources. In certain embodiments, the console provides a web-based user interface that can be used to access and manage CSPI. In some implementations, the console is a web-based application provided by the CSP.

CSPI may support single-tenancy or multi-tenancy architectures. In a single tenancy architecture, a software (e.g., an application, a database) or a hardware component (e.g., a host machine or a server) of the CSPI serves a single customer or tenant. In a multi-tenancy architecture, a software or a hardware component of the CSPI serves multiple customers or tenants. Thus, in a multi-tenancy architecture, CSPI resources are shared between multiple customers or tenants. In a multi-tenancy situation, precautions are taken, and safeguards put in place within CSPI to ensure that each tenant's data is isolated and remains invisible to other tenants.

In certain embodiments, each resource within CSPI is assigned a unique identifier called a Cloud Identifier (CID). This identifier is included as part of the resource's information and can be used to manage the resource, for example, via a Console or through APIs. An example syntax for a CID is:

cid1.<RESOURCE TYPE>.<REALM>. [REGION] [.FUTURE USE].<UNIQUE ID>
where,
cid1: The literal string indicating the version of the CID;
resource type: The type of resource (for example, instance, volume, VCN, subnet, user, group, and so on);
realm: The realm the resource is in. Example values are “c1” for the commercial realm, “c2” for the Government Cloud realm, or “c3” for the Federal Government Cloud realm, etc. Each realm may have its own domain name;
region: The region the resource is in. If the region is not applicable to the resource, this part might be blank;
future use: Reserved for future use.
unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

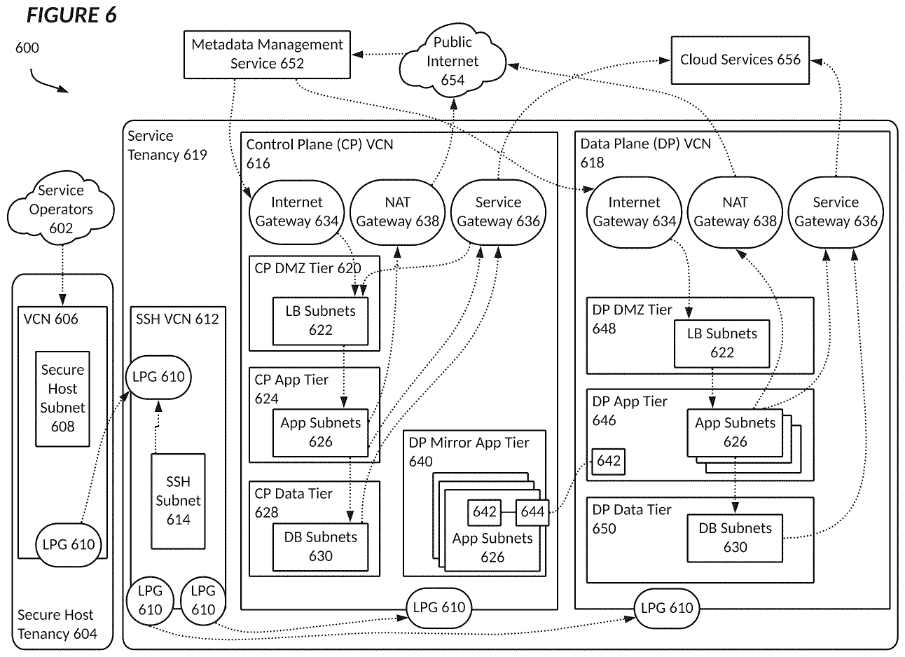

FIG. 6 is a block diagram 600 illustrating an example pattern of an IaaS architecture, according to at least one embodiment. Service operators 602 can be communicatively coupled to a secure host tenancy 604 that can include a virtual cloud network (VCN) 606 and a secure host subnet 608. In some examples, the service operators 602 may be using one or more client computing devices, that may be portable handheld devices (e.g., an iPhone®, cellular telephone, an iPad®, computing tablet, a personal digital assistant (PDA)) or wearable devices (e.g., a Google Glass® head mounted display), executing software, such as Microsoft Windows Mobile®, and/or a variety of mobile operating systems, such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, by way of example, including personal computers and/or laptop computers that are executing various versions of Microsoft Windows®, Apple Macintosh®, and/or Linux operating systems. The client computing devices can be workstation computers executing any of a variety of commercially available UNIX® or UNIX-like operating systems that include, for example, GNU/Linux operating systems and Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 606 can include a local peering gateway (LPG) 610 that can be communicatively coupled to a secure shell (SSH) VCN 612 via an LPG 610 implemented in the SSH VCN 612. The SSH VCN 612 can include an SSH subnet 614, and the SSH VCN 612 can be communicatively coupled to a control plane VCN 616 via the LPG 610 implemented in the control plane VCN 616. Also, the SSH VCN 612 can be communicatively coupled to a data plane VCN 618 via an LPG 610. The control plane VCN 616 and the data plane VCN 618 can be implemented in a service tenancy 619 that can be owned and/or operated by the IaaS provider.

The control plane VCN 616 can include a control plane demilitarized zone (DMZ) tier 620 that acts as a perimeter network (e.g., portions of a corporate network between the corporate intranet and external networks). The DMZ-based servers may have restricted responsibilities and help keep breaches contained. Additionally, the DMZ tier 620 can include one or more load balancer (LB) subnet(s) 622, a control plane app tier 624 that can include app subnet(s) 626, a control plane data tier 628 that can include database (DB) subnet(s) 630 (e.g., frontend DB subnet(s) and/or backend DB subnet(s)). The LB subnet(s) 622 in the control plane DMZ tier 620 can be communicatively coupled to the app subnet(s) 626 in the control plane app tier 624 and an Internet gateway 634 that can be implemented in the control plane VCN 616. The app subnet(s) 626 can be communicatively coupled to the DB subnet(s) 630 implemented in the control plane data tier 628 and a service gateway 636 and a network address translation (NAT) gateway 638. The control plane VCN 616 can include the service gateway 636 and the NAT gateway 638.

The control plane VCN 616 can include a data plane mirror app tier 640 that can include app subnet(s) 626. The app subnet(s) 626 implemented in the data plane mirror app tier 640 can include a virtual network interface controller (VNIC) 642 that can execute a compute instance 644. The compute instance 644 can communicatively couple the app subnet(s) 626 of the data plane mirror app tier 640 to app subnet(s) 626 that can be implemented in a data plane app tier 646.

The data plane VCN 618 can include the data plane app tier 646, a data plane DMZ tier 648, and a data plane data tier 650. The data plane DMZ tier 648 can include LB subnet(s) 622 that can be communicatively coupled to the app subnet(s) 626 of the data plane app tier 646 and the Internet gateway 634 of the data plane VCN 618. The app subnet(s) 626 can be communicatively coupled to the service gateway 636 of the data plane VCN 618 and the NAT gateway 638 of the data plane VCN 618. The data plane data tier 650 can also include the DB subnet(s) 630 that can be communicatively coupled to the app subnet(s) 626 of the data plane app tier 646.

The Internet gateway 634 of the control plane VCN 616 and of the data plane VCN 618 can be communicatively coupled to a metadata management service 652 that can be communicatively coupled to public Internet 654. Public Internet 654 can be communicatively coupled to the NAT gateway 638 of the control plane VCN 616 and of the data plane VCN 618. The service gateway 636 of the control plane VCN 616 and of the data plane VCN 618 can be communicatively couple to cloud services 656.

In some examples, the service gateway 636 of the control plane VCN 616 or of the data plane VCN 618 can make application programming interface (API) calls to cloud services 656 without going through public Internet 654. The API calls to cloud services 656 from the service gateway 636 can be one-way; the service gateway 636 can make API calls to cloud services 656, and cloud services 656 can send requested data to the service gateway 636. However, cloud services 656 may not initiate API calls to the service gateway 636.

In some examples, the secure host tenancy 604 can be directly connected to the service tenancy 619. The service tenancy 619 may otherwise be isolated. The secure host subnet 608 can communicate with the SSH subnet 614 through an LPG 610 that may enable two-way communication over an otherwise isolated system. Connecting the secure host subnet 608 to the SSH subnet 614 may give the secure host subnet 608 access to other entities within the service tenancy 619.

The control plane VCN 616 may allow users of the service tenancy 619 to set up or otherwise provision resources. Resources provisioned in the control plane VCN 616 may be deployed or otherwise used in the data plane VCN 618. In some examples, the control plane VCN 616 can be isolated from the data plane VCN 618, and the data plane mirror app tier 640 of the control plane VCN 616 can communicate with the data plane app tier 646 of the data plane VCN 618 via VNICs 642 that can be implemented in the data plane mirror app tier 640 and the data plane app tier 646.

In some examples, users or customers, of the system, can make requests, for example create, read, update, or delete (CRUD) operations, through public Internet 654 that can communicate the requests to the metadata management service 652. The metadata management service 652 can communicate the request to the control plane VCN 616 through the Internet gateway 634. The request can be received by the LB subnet(s) 622 implemented in the control plane DMZ tier 620. The LB subnet(s) 622 may determine that the request is valid, and in response, the LB subnet(s) 622 can transmit the request to app subnet(s) 626 implemented in the control plane app tier 624. If the request is validated and requires a call to public Internet 654, the call to public Internet 654 may be transmitted to the NAT gateway 638 that can make the call to public Internet 654. Metadata to be stored by the request can be stored in the DB subnet(s) 630.

In some examples, the data plane mirror app tier 640 can facilitate direct communication between the control plane VCN 616 and the data plane VCN 618. For example, changes, updates, or other suitable modifications to a configuration may need to be applied to the resources implemented in the data plane VCN 618. Via a VNIC 642, the control plane VCN 616 can directly communicate with, and can thereby execute the changes, updates, or other suitable modifications to configuration to, resources implemented in the data plane VCN 618.

In some embodiments, the control plane VCN 616 and the data plane VCN 618 can be implemented in the service tenancy 619. In this case, the user, or the customer, of the system may not own or operate either the control plane VCN 616 or the data plane VCN 618. Instead, the IaaS provider may own or operate the control plane VCN 616 and the data plane VCN 618. The control plane VCN 616 and the data plane VCN 618 may be implemented in the service tenancy 619. This embodiment can enable isolation of networks that may prevent users or customers from interacting with other users′, or other customers′, resources. Also, this embodiment may allow users, or customers, of the system to store databases privately without needing to rely on public Internet 654, that may not have a sufficient level of threat protection, for storage.

In other embodiments, the LB subnet(s) 622 implemented in the control plane VCN 616 can be configured to receive a signal from the service gateway 636. In this embodiment, the control plane VCN 616 and the data plane VCN 618 may be configured to be called by a customer of the IaaS provider without calling public Internet 654. Customers of the IaaS provider may need this embodiment since database(s) that the customers use may be controlled by the IaaS provider and may be stored on the service tenancy 619. The service tenancy 619 may be isolated from public Internet 654.

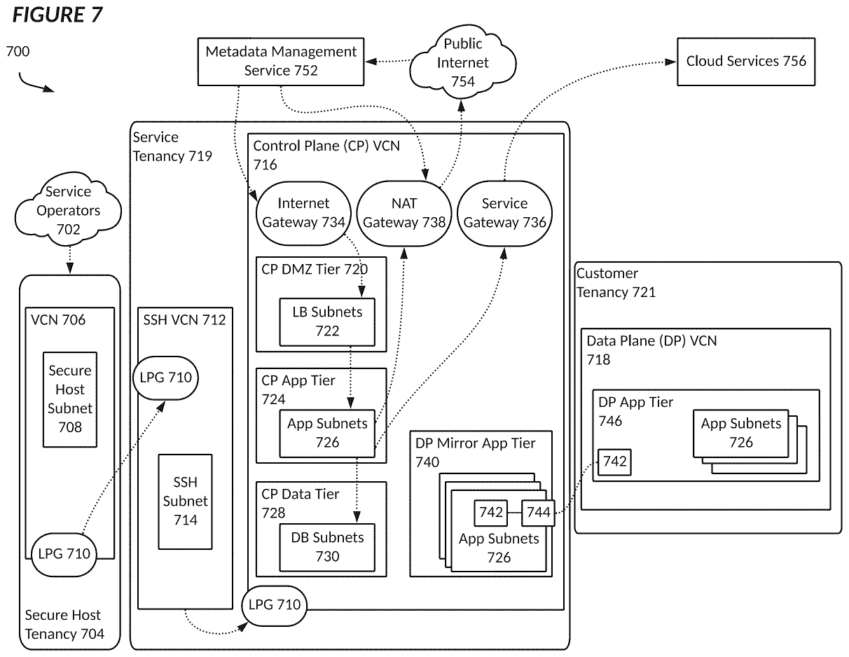

FIG. 7 is a block diagram 700 illustrating another example pattern of an IaaS architecture, according to at least one embodiment. Service operators 702 (e.g., service operators 602 of FIG. 6) can be communicatively coupled to a secure host tenancy 704 (e.g., the secure host tenancy 604 of FIG. 6) that can include a virtual cloud network (VCN) 706 (e.g., the VCN 606 of FIG. 6) and a secure host subnet 708 (e.g., the secure host subnet 608 of FIG. 6). The VCN 706 can include a local peering gateway (LPG) 710 (e.g., the LPG 610 of FIG. 6) that can be communicatively coupled to a secure shell (SSH) VCN 712 (e.g., the SSH VCN 612 of FIG. 6) via an LPG 710 implemented in the SSH VCN 712. The SSH VCN 712 can include an SSH subnet 714 (e.g., the SSH subnet 614 of FIG. 6), and the SSH VCN 712 can be communicatively coupled to a control plane VCN 716 (e.g., the control plane VCN 616 of FIG. 6) via an LPG 710 implemented in the control plane VCN 716. The control plane VCN 716 can be implemented in a service tenancy 719 (e.g., the service tenancy 619 of FIG. 6), and the data plane VCN 718 (e.g., the data plane VCN 618 of FIG. 6) can be implemented in a customer tenancy 721 that may be owned or operated by users, or customers, of the system.

The control plane VCN 716 can include a control plane DMZ tier 720 (e.g., the control plane DMZ tier 620 of FIG. 6) that can include LB subnet(s) 722 (e.g., LB subnet(s) 622 of FIG. 6), a control plane app tier 724 (e.g., the control plane app tier 624 of FIG. 6) that can include app subnet(s) 726 (e.g., app subnet(s) 626 of FIG. 6), and a control plane data tier 728 (e.g., the control plane data tier 628 of FIG. 6) that can include database (DB) subnet(s) 730 (e.g., similar to DB subnet(s) 630 of FIG. 6). The LB subnet(s) 722 implemented in the control plane DMZ tier 720 can be communicatively coupled to the app subnet(s) 726 implemented in the control plane app tier 724 and an Internet gateway 734 (e.g., the Internet gateway 634 of FIG. 6) that can be implemented in the control plane VCN 716. The app subnet(s) 726 can be communicatively coupled to the DB subnet(s) 730 implemented in the control plane data tier 728 and a service gateway 736 (e.g., the service gateway 636 of FIG. 6) and a network address translation (NAT) gateway 738 (e.g., the NAT gateway 638 of FIG. 6). The control plane VCN 716 can include the service gateway 736 and the NAT gateway 738.

The control plane VCN 716 can include a data plane mirror app tier 740 (e.g., the data plane mirror app tier 640 of FIG. 6) that can include app subnet(s) 726. The app subnet(s) 726 implemented in the data plane mirror app tier 740 can include a virtual network interface controller (VNIC) 742 (e.g., the VNIC of 642) that can execute a compute instance 744 (e.g., similar to the compute instance 644 of FIG. 6). The compute instance 744 can facilitate communication between the app subnet(s) 726 of the data plane mirror app tier 740 and the app subnet(s) 726 that can be implemented in a data plane app tier 746 (e.g., the data plane app tier 646 of FIG. 6). The compute instance 744 can facilitate this communication via the VNIC 742 implemented in the data plane mirror app tier 740 and the VNIC 742 implemented in the data plane app tier 746.

The Internet gateway 734 implemented in the control plane VCN 716 can be communicatively coupled to a metadata management service 752 (e.g., the metadata management service 652 of FIG. 6) that can be communicatively coupled to public Internet 754 (e.g., public Internet 654 of FIG. 6). Public Internet 754 can be communicatively coupled to the NAT gateway 738 implemented in the control plane VCN 716. The service gateway 736 implemented in the control plane VCN 716 can be communicatively couple to cloud services 756 (e.g., cloud services 656 of FIG. 6).

In some examples, the data plane VCN 718 can be implemented in the customer tenancy 721. In this case, the IaaS provider may provide the control plane VCN 716 for a customer, and the IaaS provider may, for a customer, set up a unique, compute instance 744 that is implemented in the service tenancy 719. A compute instance 744 may allow communication between the control plane VCN 716 implemented in the service tenancy 719 and the data plane VCN 718 that is implemented in the customer tenancy 721. The compute instance 744 may allow resources provisioned in the control plane VCN 716 that is implemented in the service tenancy 719 to be deployed or otherwise used in the data plane VCN 718 that is implemented in the customer tenancy 721.

In other examples, the customer of the IaaS provider may have databases that are implemented in the customer tenancy 721. In this example, the control plane VCN 716 can include the data plane mirror app tier 740 that can include app subnet(s) 726. The data plane mirror app tier 740 can be implemented in the control plane VCN 716, but the data plane mirror app tier 740 may not be implemented in the data plane VCN 718. That is, the data plane mirror app tier 740 may have access to the customer tenancy 721, but the data plane mirror app tier 740 may not exist in the data plane VCN 718 or be owned or operated by the customer of the IaaS provider. The data plane mirror app tier 740 may be configured to make calls to the data plane VCN 718 but may not be configured to make calls to any entity implemented in the control plane VCN 716. The customer may need to deploy or otherwise use resources in the data plane VCN 718 that are provisioned in the control plane VCN 716, and the data plane mirror app tier 740 can facilitate the deployment or other usage of resources of the customer.

In some embodiments, the customer of the IaaS provider can apply filters to the data plane VCN 718. In this embodiment, the customer can determine what the data plane VCN 718 can access, and the customer may restrict access to public Internet 754 from the data plane VCN 718. The IaaS provider may not be able to apply filters or otherwise control access of the data plane VCN 718 to any outside networks or databases. Applying filters and controls by the customer onto the data plane VCN 718, implemented in the customer tenancy 721, can help isolate the data plane VCN 718 from other customers and from public Internet 754.

In some embodiments, cloud services 756 can be called by the service gateway 736 to access services that may not exist on public Internet 754, on the control plane VCN 716, or on the data plane VCN 718. The connection between cloud services 756 and the control plane VCN 716 or the data plane VCN 718 may not be active or continuous. Cloud services 756 may exist on a different network owned or operated by the IaaS provider. Cloud services 756 may be configured to receive calls from the service gateway 736 and may be configured to not receive calls from public Internet 754. Some cloud services 756 may be isolated from other cloud services 756, and the control plane VCN 716 may be isolated from cloud services 756 that may not be in the same region as the control plane VCN 716. For example, the control plane VCN 716 may be located in “Region 1,” and cloud service “Deployment 1” may be located in Region 1 and in “Region 2.” If a call to Deployment 1 is made by the service gateway 736 implemented in the control plane VCN 716 located in Region 1, the call may be transmitted to Deployment 1 in Region 1. In this example, the control plane VCN 716, or Deployment 1 in Region 1, may not be communicatively coupled to, or otherwise in communication with, Deployment 1 in Region 2.

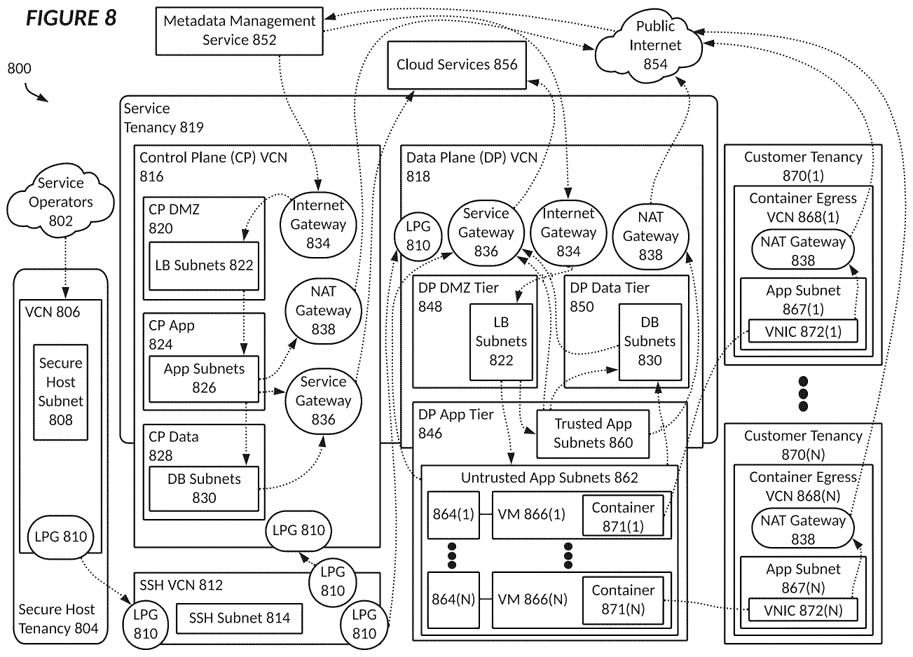

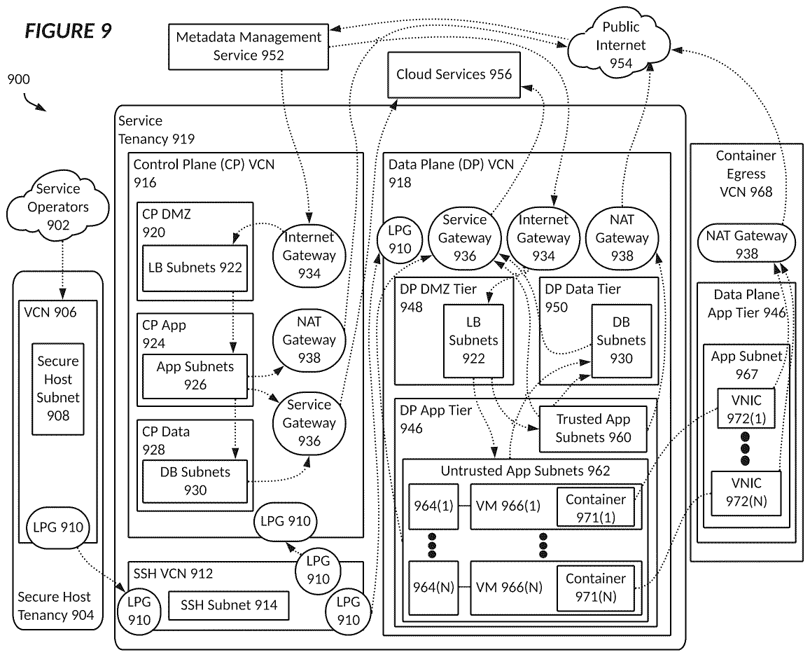

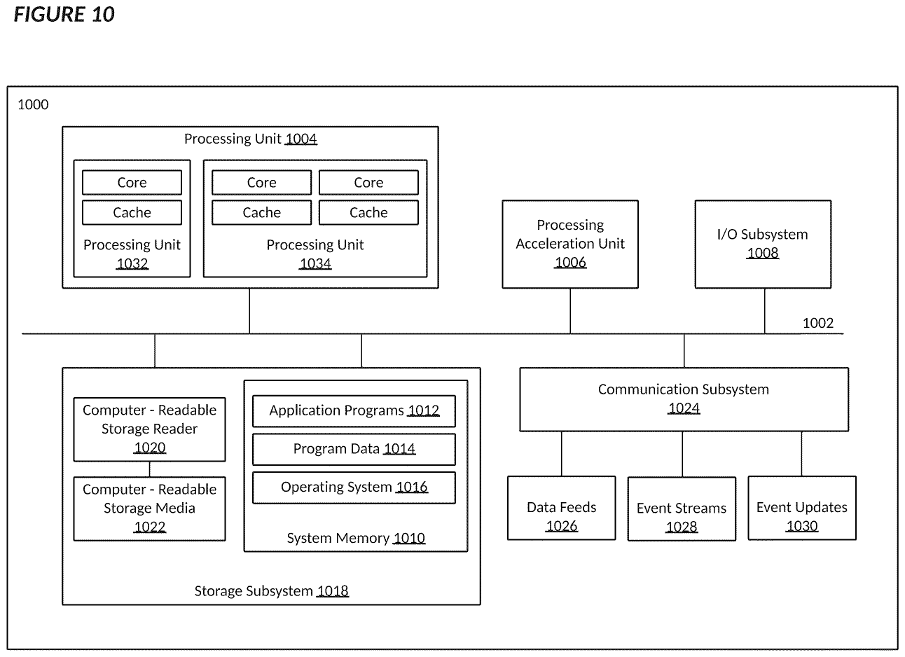

FIG. 8 is a block diagram 800 illustrating another example pattern of an IaaS architecture, according to at least one embodiment. Service operators 802 (e.g., service operators 602 of FIG. 6) can be communicatively coupled to a secure host tenancy 804 (e.g., the secure host tenancy 604 of FIG. 6) that can include a virtual cloud network (VCN) 806 (e.g., the VCN 606 of FIG. 6) and a secure host subnet 808 (e.g., the secure host subnet 608 of FIG. 6). The VCN 806 can include an LPG 810 (e.g., the LPG 610 of FIG. 6) that can be communicatively coupled to an SSH VCN 812 (e.g., the SSH VCN 612 of FIG. 6) via an LPG 810 implemented in the SSH VCN 812. The SSH VCN 812 can include an SSH subnet 814 (e.g., the SSH subnet 614 of FIG. 6), and the SSH VCN 812 can be communicatively coupled to a control plane VCN 816 (e.g., the control plane VCN 616 of FIG. 6) via an LPG 810 implemented in the control plane VCN 816 and to a data plane VCN 818 (e.g., the data plane VCN 618 of FIG. 6) via an LPG 810 implemented in the data plane VCN 818. The control plane VCN 816 and the data plane VCN 818 can be implemented in a service tenancy 819 (e.g., the service tenancy 619 of FIG. 6).

The control plane VCN 816 can include a control plane DMZ tier 820 (e.g., the control plane DMZ tier 620 of FIG. 6) that can include load balancer (LB) subnet(s) 822 (e.g., LB subnet(s) 622 of FIG. 6), a control plane app tier 824 (e.g., the control plane app tier 624 of FIG. 6) that can include app subnet(s) 826 (e.g., similar to app subnet(s) 626 of FIG. 6), and a control plane data tier 828 (e.g., the control plane data tier 628 of FIG. 6) that can include DB subnet(s) 830. The LB subnet(s) 822 implemented in the control plane DMZ tier 820 can be communicatively coupled to the app subnet(s) 826 implemented in the control plane app tier 824 and to an Internet gateway 834 (e.g., the Internet gateway 634 of FIG. 6) that can be implemented in the control plane VCN 816, and the app subnet(s) 826 can be communicatively coupled to the DB subnet(s) 830 implemented in the control plane data tier 828 and to a service gateway 836 (e.g., the service gateway of FIG. 6) and a network address translation (NAT) gateway 838 (e.g., the NAT gateway 638 of FIG. 6). The control plane VCN 816 can include the service gateway 836 and the NAT gateway 838.

The data plane VCN 818 can include a data plane app tier 846 (e.g., the data plane app tier 646 of FIG. 6), a data plane DMZ tier 848 (e.g., the data plane DMZ tier 648 of FIG. 6), and a data plane data tier 850 (e.g., the data plane data tier 650 of FIG. 6). The data plane DMZ tier 848 can include LB subnet(s) 822 that can be communicatively coupled to trusted app subnet(s) 860, untrusted app subnet(s) 862 of the data plane app tier 846, and the Internet gateway 834 implemented in the data plane VCN 818. The trusted app subnet(s) 860 can be communicatively coupled to the service gateway 836 implemented in the data plane VCN 818, the NAT gateway 838 implemented in the data plane VCN 818, and DB subnet(s) 830 implemented in the data plane data tier 850. The untrusted app subnet(s) 862 can be communicatively coupled to the service gateway 836 implemented in the data plane VCN 818 and DB subnet(s) 830 implemented in the data plane data tier 850. The data plane data tier 850 can include DB subnet(s) 830 that can be communicatively coupled to the service gateway 836 implemented in the data plane VCN 818.

The untrusted app subnet(s) 862 can include one or more primary VNICs 864(1)-(N) that can be communicatively coupled to tenant virtual machines (VMs) 866(1)-(N). Tenant VMs 866(1)-(N) can be communicatively coupled to a respective app subnets 867(1)-(N) that can be implemented in respective container egress VCNs 868(1)-(N) that can be implemented in respective customer tenancies 870(1)-(N). Respective secondary VNICs 872(1)-(N) can facilitate communication between the untrusted app subnet(s) 862 implemented in the data plane VCN 818 and the app subnet implemented in the container egress VCNs 868(1)-(N). Container egress VCNs 868(1)-(N) can include a NAT gateway 838 that can be communicatively coupled to public Internet 854 (e.g., public Internet 654 of FIG. 6).

The Internet gateway 834 implemented in the control plane VCN 816 and implemented in the data plane VCN 818 can be communicatively coupled to a metadata management service 852 (e.g., the metadata management service 652 of FIG. 6) that can be communicatively coupled to public Internet 854. Public Internet 854 can be communicatively coupled to the NAT gateway 838 implemented in the control plane VCN 816 and implemented in the data plane VCN 818. The service gateway 836 implemented in the control plane VCN 816 and implemented in the data plane VCN 818 can be communicatively couple to cloud services 856.

In some embodiments, the data plane VCN 818 can be integrated with customer tenancies 870(1)-(N). This integration can be useful or needed for customers of the IaaS provider in some cases such as a case that may need support when executing code. The customer may provide code to execute that may be destructive, may communicate with other customer resources, or may otherwise cause undesirable effects. In response to this, the IaaS provider may determine whether or not to execute code given to the IaaS provider by the customer.

In some examples, the customer of the IaaS provider may grant temporary network access to the IaaS provider and request a function to be attached to the data plane app tier 846. Code to execute the function may be executed in the VMs 866(1)-(N), and the code may not be configured to execute anywhere else on the data plane VCN 818. VMs 866(1)-(N) may be connected to one customer tenancy 870(1). Respective containers 871(1)-(N) implemented in the VMs 866(1)-(N) may be configured to execute the code. In this case, there can be a dual isolation (e.g., the containers 871(1)-(N) executing code), where the containers 871(1)-(N) may be implemented in at least the VM 866(1)-(N) that are implemented in the untrusted app subnet(s) 862) that may help prevent incorrect or otherwise undesirable code from damaging the network of the IaaS provider or from damaging a network of a different customer. The containers 871(1)-(N) may be communicatively coupled to the customer tenancy 870 and may be configured to transmit or receive data from the customer tenancy 870. The containers 871(1)-(N) may not be configured to transmit or receive data from any other entity in the data plane VCN 818. Upon completing execution of the code, the IaaS provider may terminate or otherwise dispose of the containers 871(1)-(N).

In some embodiments, the trusted app subnet(s) 860 may execute code that may be owned or operated by the IaaS provider. In this embodiment, the trusted app subnet(s) 860 may be communicatively coupled to the DB subnet(s) 830 and be configured to execute CRUD operations in the DB subnet(s) 830. The untrusted app subnet(s) 862 may be communicatively coupled to the DB subnet(s) 830, but in this embodiment, the untrusted app subnet(s) may be configured to execute read operations in the DB subnet(s) 830. The containers 871(1)-(N) that can be implemented in the VM 866(1)-(N) of a customer and that may execute code from the customer may not be communicatively coupled with the DB subnet(s) 830.

In other embodiments, the control plane VCN 816 and the data plane VCN 818 may not be directly communicatively coupled. In this embodiment, there may be no direct communication between the control plane VCN 816 and the data plane VCN 818. However, communication can occur indirectly through at least one method. An LPG 810 may be established by the IaaS provider that can facilitate communication between the control plane VCN 816 and the data plane VCN 818. In another example, the control plane VCN 816 or the data plane VCN 818 can make a call to cloud services 856 via the service gateway 836. For example, a call to cloud services 856 from the control plane VCN 816 can include a request for a service that can communicate with the data plane VCN 818.

FIG. 9 is a block diagram illustrating another example pattern of an IaaS architecture 900 according to at least one embodiment. Service operators 902 (e.g., service operators 602 of FIG. 6) can be communicatively coupled to a secure host tenancy 904 (e.g., the secure host tenancy 604 of FIG. 6) that can include a virtual cloud network (VCN) 906 (e.g., the VCN 606 of FIG. 6) and a secure host subnet 908 (e.g., the secure host subnet 608 of FIG. 6). The VCN 906 can include an LPG 910 (e.g., the LPG 610 of FIG. 6) that can be communicatively coupled to an SSH VCN 912 (e.g., the SSH VCN 612 of FIG. 6) via an LPG 910 implemented in the SSH VCN 912. The SSH VCN 912 can include an SSH subnet 914 (e.g., the SSH subnet 614 of FIG. 6), and the SSH VCN 912 can be communicatively coupled to a control plane VCN 916 (e.g., the control plane VCN 616 of FIG. 6) via an LPG 910 implemented in the control plane VCN 916 and to a data plane VCN 918 (e.g., the data plane VCN 618 of FIG. 6) via an LPG 910 implemented in the data plane VCN 918. The control plane VCN 916 and the data plane VCN 918 can be implemented in a service tenancy 919 (e.g., the service tenancy 619 of FIG. 6).

The control plane VCN 916 can include a control plane DMZ tier 920 (e.g., the control plane DMZ tier 620 of FIG. 6) that can include LB subnet(s) 922 (e.g., LB subnet(s) 622 of FIG. 6), a control plane app tier 924 (e.g., the control plane app tier 624 of FIG. 6) that can include app subnet(s) 926 (e.g., app subnet(s) 626 of FIG. 6), and a control plane data tier 928 (e.g., the control plane data tier 628 of FIG. 6) that can include DB subnet(s) 930 (e.g., DB subnet(s) 830 of FIG. 8). The LB subnet(s) 922 implemented in the control plane DMZ tier 920 can be communicatively coupled to the app subnet(s) 926 implemented in the control plane app tier 924 and to an Internet gateway 934 (e.g., the Internet gateway 634 of FIG. 6) that can be implemented in the control plane VCN 916, and the app subnet(s) 926 can be communicatively coupled to the DB subnet(s) 930 implemented in the control plane data tier 928 and to a service gateway 936 (e.g., the service gateway of FIG. 6) and a network address translation (NAT) gateway 938 (e.g., the NAT gateway 638 of FIG. 6). The control plane VCN 916 can include the service gateway 936 and the NAT gateway 938.

The data plane VCN 918 can include a data plane app tier 946 (e.g., the data plane app tier 646 of FIG. 6), a data plane DMZ tier 948 (e.g., the data plane DMZ tier 648 of FIG. 6), and a data plane data tier 950 (e.g., the data plane data tier 650 of FIG. 6). The data plane DMZ tier 948 can include LB subnet(s) 922 that can be communicatively coupled to trusted app subnet(s) 960 (e.g., trusted app subnet(s) 860 of FIG. 8) and untrusted app subnet(s) 962 (e.g., untrusted app subnet(s) 862 of FIG. 8) of the data plane app tier 946 and the Internet gateway 934 implemented in the data plane VCN 918. The trusted app subnet(s) 960 can be communicatively coupled to the service gateway 936 implemented in the data plane VCN 918, the NAT gateway 938 implemented in the data plane VCN 918, and DB subnet(s) 930 implemented in the data plane data tier 950. The untrusted app subnet(s) 962 can be communicatively coupled to the service gateway 936 implemented in the data plane VCN 918 and DB subnet(s) 930 implemented in the data plane data tier 950. The data plane data tier 950 can include DB subnet(s) 930 that can be communicatively coupled to the service gateway 936 implemented in the data plane VCN 918.

The untrusted app subnet(s) 962 can include primary VNICs 964(1)-(N) that can be communicatively coupled to tenant virtual machines (VMs) 966(1)-(N) implemented within the untrusted app subnet(s) 962. Tenant VMs 966(1)-(N) can execute code in a respective container 967(1)-(N) and be communicatively coupled to an app subnet 967 that can be implemented in a data plane app tier 946 that can be implemented in a container egress VCN 968. Respective secondary VNICs 972(1)-(N) can facilitate communication between the untrusted app subnet(s) 962 implemented in the data plane VCN 918 and the app subnet 967 implemented in the container egress VCN 968. The container egress VCN 968 can include a NAT gateway 938 that can be communicatively coupled to public Internet 954 (e.g., public Internet 654 of FIG. 6).

The Internet gateway 934 implemented in the control plane VCN 916 and implemented in the data plane VCN 918 can be communicatively coupled to a metadata management service 952 (e.g., the metadata management service 652 of FIG. 6) that can be communicatively coupled to public Internet 954. Public Internet 954 can be communicatively coupled to the NAT gateway 938 implemented in the control plane VCN 916 and implemented in the data plane VCN 918. The service gateway 936 implemented in the control plane VCN 916 and implemented in the data plane VCN 918 can be communicatively couple to cloud services 956.

In some examples, the pattern illustrated by the architecture of block diagram 900 of FIG. 9 may be considered an exception to the pattern illustrated by the architecture of block diagram 800 of FIG. 8 and may be needed for a customer of the IaaS provider if the IaaS provider cannot directly communicate with the customer (e.g., a disconnected region). The respective containers 971(1)-(N) that are implemented in the VMs 966(1)-(N) for a customer can be accessed in real-time by the customer. The containers 971(1)-(N) may be configured to make calls to respective secondary VNICs 972(1)-(N) implemented in app subnet(s) 967 of the data plane app tier 946 that can be implemented in the container egress VCN 968. The secondary VNICs 972(1)-(N) can transmit the calls to the NAT gateway 938 that may transmit the calls to public Internet 954. In this example, the containers 971(1)-(N) that can be accessed in real time by the customer can be isolated from the control plane VCN 916 and can be isolated from other entities implemented in the data plane VCN 918. The containers 971(1)-(N) may also be isolated from resources from other customers.

In other examples, the customer can use the containers 971(1)-(N) to call cloud services 956. In this example, the customer may execute code in the containers 971(1)-(N) that request a service from cloud services 956. The containers 971(1)-(N) can transmit this request to the secondary VNICs 972(1)-(N) that can transmit the request to the NAT gateway 938 that can transmit the request to public Internet 954. Public Internet 954 can transmit the request to LB subnet(s) 922 implemented in the control plane VCN 916 via the Internet gateway 934. In response to determining the request is valid, the LB subnet(s) can transmit the request to app subnet(s) 926 that can transmit the request to cloud services 956 via the service gateway 936.

It should be appreciated that IaaS architectures 600, 700, 800, and 900 may include components that are different and/or additional to the components shown in the figures. Furthermore, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. A node may be local to and/or remote from another node. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network may be associated with both an overlay address (for data to be addressed to the overlay node) and an underlay address (for data to be addressed to the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of other clients. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources may be provisioned for a validation entity that is independent from other entities (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud may have dependencies on applications implemented at the public cloud and vice-versa. A call from an application at the private cloud to an application at the public cloud (and vice versa) may be executed through the interface.

In an embodiment, a tenant of a multi-tenant computer network is independent of another tenant of the same multi-tenant computer network. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared across tenants. Various tenant isolation approaches may be used.

In an embodiment, a tenant is associated with a tenant ID. A network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, a data structure and/or dataset, stored by the computer network, is tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a tenant, a set of applications that the tenant is authorized to access. For an application, a list of tenant IDs of tenants authorized to access the application is stored. A tenant is permitted access to a particular application when the tenant ID of the tenant is implemented in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Computer System

FIG. 10 illustrates an example computer system 1000. An embodiment of the disclosure may be implemented upon the computer system 1000. As shown in FIG. 10, computer system 1000 includes a processing unit 1004 that communicates with peripheral subsystems via a bus subsystem 1002. These peripheral subsystems may include a processing acceleration unit 1006, an I/O subsystem 1008, a storage subsystem 1018, and a communications subsystem 1024. Storage subsystem 1018 includes tangible computer-readable storage media 1022, computer-readable storage reader 1020 and a system memory 1010.

Bus subsystem 1002 provides a mechanism for letting the various components and subsystems of computer system 1000 to communicate with other components and subsystems as intended. Although bus subsystem 1002 is shown schematically as a single bus, alternative embodiments of the bus subsystem may utilize multiple buses. Bus subsystem 1002 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the Institute of Electrical and Electronics Engineers (IEEE) P1386.1 standard.

Processing unit 1004 controls the operation of computer system 1000. Processing unit 1004 can be implemented as one or more integrated circuits (e.g., a conventional microprocessor or microcontroller). One or more processors may be implemented in processing unit 1004. These processors may include single core or multicore processors. In certain embodiments, processing unit 1004 may be implemented as one or more independent sub processing units 1032 and/or 1034 with single or multicore processors implemented in one or more processing units. In other embodiments, processing unit 1004 may also be implemented as a quad-core processing unit formed by integrating two dual-core processors into a single chip.

In various embodiments, processing unit 1004 can execute a variety of programs in response to program code and can maintain multiple concurrently executing programs or processes. At any given time, the program code to be executed can be wholly or partially implemented in processing unit 1004 and/or in storage subsystem 1018. Through suitable programming, processing unit 1004 can provide various functionalities described above. Computer system 1000 may additionally include a processing acceleration unit 1006 that can include a digital signal processor (DSP), a special-purpose processor, and/or the like.

I/O subsystem 1008 may include user interface input devices and user interface output devices. User interface input devices may include a keyboard, pointing devices, such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices, such as the Microsoft Kinect® motion sensor that enables users to control and interact with an input device, such as the Microsoft Xbox® 360 game controller, through a natural user interface using gestures and spoken commands. User interface input devices may also include eye gesture recognition devices, such as the Google Glass® blink detector, that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices, such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices, such as computed tomography, magnetic resonance imaging, position emission tomography, or medical ultrasonography devices. User interface input devices may also include audio input devices, such as MIDI keyboards, digital musical instruments and the like.

User interface output devices may include a display subsystem, indicator lights, or non-visual displays, such as audio output devices. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 1000 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 1000 may comprise a storage subsystem 1018 that provides a tangible, non-transitory, computer-readable storage medium for storing software and data constructs that provide the functionality of the embodiments described in this disclosure. The software can include programs, code modules, instructions, scripts, etc., that, when executed by one or more cores or processors of processing unit 1004, provide the functionality described above. Storage subsystem 1018 may also provide a repository for storing data used in accordance with the present disclosure.

As depicted in the example in FIG. 10, storage subsystem 1018 can include various components, including a system memory 1010, computer-readable storage media 1022, and a computer readable storage media reader 1020. System memory 1010 may store program instructions, such as application programs 1012, that are loadable and executable by processing unit 1004. System memory 1010 may also store data, such as program data 1014, that is used during the execution of the instructions and/or data that is generated during the execution of the program instructions. Various programs may be loaded into system memory 1010 including, but not limited to, client applications, Web browsers, mid-tier applications, relational database management systems (RDBMS), virtual machines, containers, etc.

System memory 1010 may also store an operating system 1016. Examples of operating system 1016 may include various versions of Microsoft Windows®, Apple Macintosh®, and/or Linux operating systems, a variety of commercially available UNIX® or UNIX-like operating systems (including without limitation the variety of GNU/Linux operating systems, the Google Chrome® OS, and the like) and/or mobile operating systems, such as iOS, Windows® Phone, Android® OS, BlackBerry® OS, and Palm® OS operating systems. In certain implementations where computer system 1000 executes one or more virtual machines, the virtual machines along with their guest operating systems (GOSs) may be loaded into system memory 1010 and executed by one or more processors or cores of processing unit 1004.

System memory 1010 can come in different configurations depending upon the type of computer system 1000. For example, system memory 1010 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 1010 may include a basic input/output system (BIOS) including basic routines that help to transfer information between elements within computer system 1000 such as during start-up.

Computer-readable storage media 1022 may represent remote, local, fixed, and/or removable storage devices plus storage media for temporarily and/or more permanently including and storing computer-readable information for use by computer system 1000, including instructions executable by processing unit 1004 of computer system 1000.

Computer-readable storage media 1022 can include any appropriate media known or used in the field, including storage media and communication media, such as but not limited to volatile and non-volatile, removable and non-removable media implemented in any method or technology for storage and/or transmission of information. This can include tangible, computer-readable storage media, such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible, computer-readable media.

By way of example, computer-readable storage media 1022 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk, such as a CD ROM, DVD, and Blu-Ray® disk, or other optical media. Computer-readable storage media 1022 may include, but is not limited to, Zip® drives, flash memory cards, universal serial bus (USB) flash drives, secure digital (SD) cards, DVD disks, digital video tape, and the like. Computer-readable storage media 1022 may also include solid-state drives (SSD) based on non-volatile memory, such as flash-memory based SSDs, enterprise flash drives, solid state ROM, and the like, SSDs based on volatile memory, such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated, computer-readable media may provide non-volatile storage of computer-readable instructions, data structures, program modules, and other data for computer system 1000.

Machine-readable instructions executable by one or more processors or cores of processing unit 1004 may be stored on a non-transitory, computer-readable storage medium. A non-transitory, computer-readable storage medium can include physically tangible memory or storage devices that include volatile memory storage devices and/or non-volatile storage devices. Examples of non-transitory, computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1024 provides an interface to other computer systems and networks. Communications subsystem 1024 serves as an interface for receiving data from and transmitting data to other systems from computer system 1000. For example, communications subsystem 1024 may enable computer system 1000 to connect to one or more devices via the Internet. In some embodiments, communications subsystem 1024 can include radio frequency (RF) transceiver components to access wireless voice and/or data networks (e.g., using cellular telephone technology, advanced data network technology, such as 3G, 4G, or EDGE (enhanced data rates for global evolution), WiFi (IEEE 1002.11 family standards, or other mobile communication technologies, or any combination thereof), global positioning system (GPS) receiver components, and/or other components. In some embodiments, communications subsystem 1024 can provide wired network connectivity (e.g., Ethernet) in addition to or instead of a wireless interface.

In some embodiments, communications subsystem 1024 may also receive input communication in the form of structured and/or unstructured data feeds 1026, event streams 1028, event updates 1030, and the like on behalf of one or more users who may use computer system 1000.

By way of example, communications subsystem 1024 may be configured to receive data feeds 1026 in real time from users of social networks and/or other communication services, such as Twitter® feeds, Facebook® updates, web feeds, such as Rich Site Summary (RSS) feeds, and/or real-time updates from one or more third party information sources.

Additionally, communications subsystem 1024 may be configured to receive data in the form of continuous data streams. The continuous data streams may include event streams 1028 of real-time events and/or event updates 1030 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 1024 may also be configured to output the structured and/or unstructured data feeds 1026, event streams 1028, event updates 1030, and the like to one or more databases that may be in communication with one or more streaming data source computers coupled to computer system 1000.

Computer system 1000 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1000 depicted in FIG. 10 is intended as a non-limiting example. Many other configurations having more or fewer components than the system depicted in FIG. 10 are possible. For example, customized hardware might also be used and/or particular elements might be implemented in hardware, firmware, software (including applets), or a combination. Furthermore, connection to other computing devices, such as network input/output devices, may be employed. Based on the disclosure and teachings provided herein, a person of ordinary skill in the art will appreciate other ways and/or methods to implement the various embodiments.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application, in the specific form in which such claims issue, including any subsequent correction.

What is claimed is:

1. A method comprising:
accessing, by an attestation record system, a plurality of attestation records, wherein:
each of the plurality of attestation records specifies a respective action to be performed on a respective computing device of a plurality of computing devices,
each of the plurality of attestation records is associated with a respective validation layer of a plurality of validation layers, and
the plurality of attestation records comprise a target attestation record dependent on a first validation layer of the plurality of validation layers;
determining, by the attestation record system, whether actions indicated by a current set of attestation records associated with the first validation layer are complete; and
subsequent to determining that the actions indicated by the current set of attestation records associated with the first validation layer are complete: executing, by a first test execution system, a first set of actions on a first computing device based on the target attestation record,
wherein the method is performed by at least one device including a hardware processor.

2. The method of claim 1, wherein determining whether the actions indicated by the current set of attestation records associated with the first validation layer are complete comprises:
identifying a current subset of the plurality of attestation records that are associated with the first validation layer; and
determining whether actions indicated by the current subset of the plurality of attestation records are complete.

3. The method of claim 1, further comprising:
causing, by the attestation record system, the first test execution system to execute the first set of actions on the first computing device based on the target attestation record.

4. The method of claim 1, wherein performance of the actions indicated by the plurality of attestation records is prerequisite to granting a client access to the set of computing devices.

5. The method of claim 1, wherein the plurality of attestation records are recorded into the attestation record system by a plurality of test execution systems.

6. The method of claim 1, wherein the plurality of attestation records are recordable into the attestation record system in any order, regardless of associated validation layers.

7. The method of claim 1, wherein an additional attestation record is registered into the attestation record system and added to the plurality of attestation records subsequent to determining that the actions indicated by the current set of attestation records associated with the first validation layer are complete.

8. The method of claim 7, wherein the first set of results is received by the attestation record system from a plurality of entities.

9. The method of claim 1, wherein the first set of devices includes a set of graphics processing unit (GPU) servers.

10. The method of claim 1, wherein the plurality of attestation records comprising a second attestation record, and
wherein the second attestation record specifies (a) a second set of actions to be performed, and (b) a particular set of validation layers required to be completed prior to performing the second set of actions, wherein the particular set of validation layers includes the first validation layer.

11. The method of claim 1, further comprising:
subsequent to executing the first set of actions on the first computing device based on the target attestation record:
determining, in a second iteration by the attestation record system, whether the actions indicated by the current set of attestation records associated with the first validation layer are complete; and
subsequent to determining, in the second iteration, that the actions indicated by the current set of attestation records associated with the first validation layer are not complete:
re-executing, by the first test execution system, the first set of actions on the first computing device based on the target attestation record.

12. The method of claim 1, further comprising:
responsive to determining, in a first iteration, that the actions indicated by the current set of attestation records associated with the first validation layer are complete, transmitting, by the attestation record system, a first message indicating that the first validation layer is complete; and
responsive to determining, in a second iteration, that the actions indicated by the current set of attestation records associated with the first validation layer are not complete, transmitting, by the attestation record system, a second message indicating that the first validation layer is incomplete.

13. The method of claim 1, wherein the plurality of validation layers comprise:
a first validation layer related to facility validation comprising validation for at least one of power or cooling;
a second validation layer related to management network validation comprising validation for at least one of an Integrated Lights-Out Manager (ILOM), switch management, or a Rack Power Distribution Unit (RPDU);
a third validation layer related to network connectivity validation;
a fourth validation layer related to hardware validation;
a fifth validation layer related to server component validation;
a sixth validation layer related to intra-rack validation;
a seventh validation layer related to cohort validation, wherein a cohort comprises server racks within a defined physical boundary;
an eighth validation layer related to network plane validation; and
a ninth validation layer related to complete system validation comprising validation for a spine network.

14. One or more non-transitory computer-readable media comprising instructions that, when executed by one or more hardware processors, cause performance of operations comprising:
accessing, by an attestation record system, a plurality of attestation records, wherein:
each of the plurality of attestation records specifies a respective action to be performed on a respective computing device of a plurality of computing devices, and
each of the plurality of attestation records is associated with a respective validation layer of a plurality of validation layers, and
the plurality of attestation records comprise a target attestation record dependent on a first validation layer of the plurality of validation layers;
determining, by the attestation record system, whether actions indicated by a current set of attestation records associated with the first validation layer are complete; and
subsequent to determining that the actions indicated by the current set of attestation records associated with the first validation layer are complete: executing, by a first test execution system, a first set of actions on a first computing device based on the target attestation record.

15. The one or more non-transitory computer-readable media of claim 14, wherein determining whether the actions indicated by the current set of attestation records associated with the first validation layer are complete comprises:
identifying a current subset of the plurality of attestation records that are associated with the first validation layer; and
determining whether actions indicated by the current subset of the plurality of attestation records are complete.

16. The one or more non-transitory computer-readable media of claim 14, further comprising:
causing, by the attestation record system, the first test execution system to execute the first set of actions on the first computing device based on the target attestation record.

17. The one or more non-transitory computer-readable media of claim 14, wherein performance of the actions indicated by the plurality of attestation records is prerequisite to granting a client access to the set of computing devices.

18. The one or more non-transitory computer-readable media of claim 14, wherein the plurality of attestation records are recorded into the attestation record system by a plurality of test execution systems.

19. The one or more non-transitory computer-readable media of claim 14, wherein the plurality of attestation records are recordable into the attestation record system in any order, regardless of associated validation layers.

20. A system comprising:
one or more hardware processors;
one or more non-transitory computer-readable media; and
program instructions stored on the one or more non-transitory computer-readable media which, when executed by the one or more hardware processors, cause the system to perform operations comprising:
accessing, by an attestation record system, a plurality of attestation records, wherein:
each of the plurality of attestation records specifies a respective action to be performed on a respective computing device of a plurality of computing devices,
each of the plurality of attestation records is associated with a respective validation layer of a plurality of validation layers, and
the plurality of attestation records comprise a target attestation record dependent on a first validation layer of the plurality of validation layers;
determining, by the attestation record system, whether actions indicated by a current set of attestation records associated with the first validation layer are complete; and
subsequent to determining that the actions indicated by the current set of attestation records associated with the first validation layer are complete: executing, by a first test execution system, a first set of actions on a first computing device based on the target attestation record.
